(19) United States
(12) Patent Application Publication
(10) Pub. No.: US 2025/0173149 A1
(43) Pub. Date: May 29, 2025

(54) APPARATUS AND METHOD FOR RECONCILING CONFLICTING CACHELINE MODIFICATIONS

(71) Applicant: Intel Corporation, Santa Clara, CA (US)

(72) Inventors: Vincent CAVE, Hillsboro, OR (US); Robert PAWLOWSKI, Beaverton, OR (US)

(21) Appl. No.: 18/522,059

(22) Filed: Nov. 28, 2023

(51) Int. Cl. G06F 9/38

(52) U.S. Cl. CPC G06F 9/3816; G06F 9/3867

(57) ABSTRACT

Apparatus and method for reconciling cache line modifications. For example, one embodiment of a processor comprises: a plurality of instruction processing pipelines, each instruction processing pipeline to process sequences of instructions; an interconnect coupled to the plurality of instruction processing pipelines; and a memory subsystem coupled to plurality of instruction processing pipelines over the interconnect, the memory subsystem comprising a plurality of atomic operation circuits corresponding to a plurality of memory interfaces to be coupled to a corresponding plurality of memories, each atomic operation circuit configured to perform a corresponding reduction operation with first data stored in the memory and second data indicated in a command packet, the atomic operation circuit to generate result data based on the reduction operation which is to be stored in the memory.

This invention was made with Government support under contract number W911NF-22-C-0081-0106. The Government has certain rights in this invention.

### BACKGROUND

### Field of the Invention

This invention relates generally to the field of computer processors. More particularly, the invention relates to an apparatus and method for reconciling conflicting cacheline modifications.

### Description of the Related Art

Large scale shared-memory systems typically rely on the concept of “islands” of coherence domains. In these approaches, while subsets of cores within the system are locally coherent, no global coherence is enforced because of the system scalability effects on coherency performance, protocol complexity, and storage overheads. There are significant programming challenges with such a system due to the difficulty for developers to reason about and operate on data. In this environment, a structured programming approach is necessary for applications spanning multiple nodes in the system to execute safely.

Specifically, the structured programming approach allows programmers to express and schedule parallel code regions. Developers can fork (create) work to be executed in parallel by cores across the shared-memory system. Similarly, to join (finish), is to ensure all the forked parallel work has completed (i.e., when no more related instructions are to run on any participating cores). Such parallel code regions clearly define entry and exit points in code, which allows programmers to define how data flows in and out of the code region.

While this programming approach-if properly adhered to-results in correct data in global shared structures, it incurs a significant performance limitation due to the overhead of software managed coherency. To maintain coherent data for concurrently-accessed global structures, the software must ensure the accessing of that data from only a single coherent island in the system (via the aforementioned structured approach). Once finished with the current phase, all caches in that coherency island must flush their modified data back to memory, wait for acknowledgement that the data was successfully written, and inform threads in other coherency islands that the data is ready via a global barrier.

This sequence for software-managed coherency (and the associated performance overhead) is a requirement to ensure coherent data in globally shared structures for most use cases. However, in certain scenarios, the way that the data is accessed and shared for threads in different coherency islands may be viewed as a reduction type of operation. This includes accumulations, multiplications, and min/max values. In these cases, the order that the data is modified at the shared memory location does not matter, and the only requirement for these accesses is that the data must be atomically updated. Leveraging remote atomic operations (executed near the memory endpoint) to accomplish these reduction-type operations as part of the cache-line writebacks allows for a significant performance gain by eliminating the write-ack visibility and inter-thread synchronization phases of the previously describe software managed coherency techniques.

### BRIEF DESCRIPTION OF THE DRAWINGS

A better understanding of the present invention can be obtained from the following detailed description in conjunction with the following drawings, in which:

FIG. 1 illustrates an example computer system architecture;

FIG. 2 illustrates a processor comprising a plurality of cores;

FIG. 3A illustrates a plurality of stages of a processing pipeline;

FIG. 3B illustrates details of one embodiment of a core;

FIG. 4 illustrates execution circuitry in accordance with one embodiment;

FIG. 5 illustrates one embodiment of a register architecture;

FIG. 6 illustrates one example of an instruction format;

FIG. 7 illustrates addressing techniques in accordance with one embodiment;

FIG. 8 illustrates one embodiment of an instruction prefix;

FIGS. 9A-D illustrate embodiments of how the R, X, and B fields of the prefix are used;

FIGS. 10A-B illustrate examples of a second instruction prefix;

FIG. 11 illustrates payload bytes of one embodiment of an instruction prefix;

FIG. 12 illustrates instruction conversion and binary translation implementations;

FIG. 13 illustrates one embodiment of a Programmable Integrated Unified Memory Architecture (PIUMA);

FIG. 14 illustrates an example of a local atomic buffer in accordance with embodiments of the invention;

FIG. 15 illustrates an embodiment of an atomic unit (ATMU) in accordance with embodiments of the invention;

FIG. 16 illustrates an architecture in accordance with some embodiments including ATMUs;

FIG. 17 illustrates a reduction address table in accordance with some embodiments;

FIG. 18 illustrates one embodiment with different types of request handlers; and

FIG. 19 illustrates one embodiment with cache/memory accumulation.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

### Exemplary Computer Architectures

Detailed below are describes of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

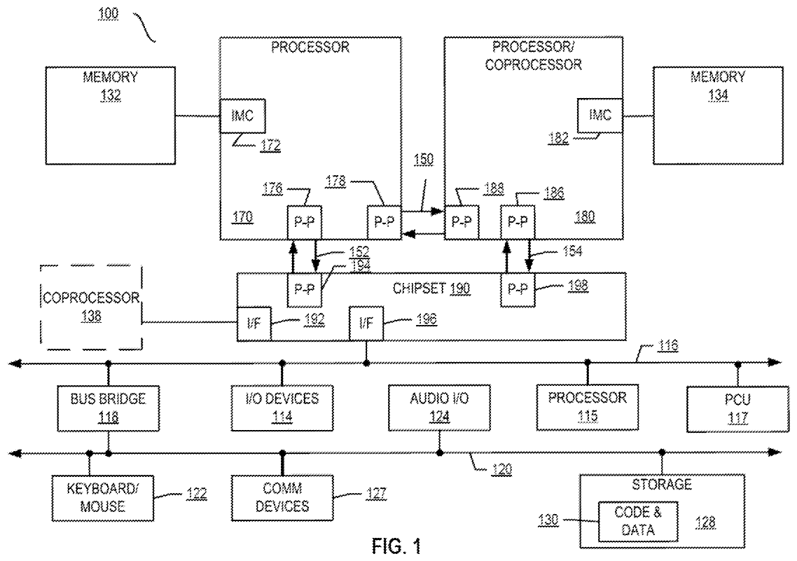

FIG. 1 illustrates embodiments of an exemplary system. Multiprocessor system 100 is a point-to-point interconnect system and includes a plurality of processors including a first processor 170 and a second processor 180 coupled via a point-to-point interconnect 150. In some embodiments, the first processor 170 and the second processor 180 are homogeneous. In some embodiments, first processor 170 and the second processor 180 are heterogenous.

Processors 170 and 180 are shown including integrated memory controller (IMC) units circuitry 172 and 182, respectively. Processor 170 also includes as part of its interconnect controller units point-to-point (P-P) interfaces 176 and 178; similarly, second processor 180 includes P-P interfaces 186 and 188. Processors 170, 180 may exchange information via the point-to-point (P-P) interconnect 150 using P-P interface circuits 178, 188. IMCs 172 and 182 couple the processors 170, 180 to respective memories, namely a memory 132 and a memory 134, which may be portions of main memory locally attached to the respective processors.

Processors 170, 180 may each exchange information with a chipset 190 via individual P-P interconnects 152, 154 using point to point interface circuits 176, 194, 186, 198. Chipset 190 may optionally exchange information with a coprocessor 138 via a high-performance interface 192. In some embodiments, the coprocessor 138 is a special-purpose processor, such as, for example, a high-throughput MIC processor, a network or communication processor, compression engine, graphics processor, GPGPU, embedded processor, or the like.

A shared cache (not shown) may be included in either processor 170, 180 or outside of both processors, yet connected with the processors via P-P interconnect, such that either or both processors' local cache information may be stored in the shared cache if a processor is placed into a low power mode.

Chipset 190 may be coupled to a first interconnect 116 via an interface 196. In some embodiments, first interconnect 116 may be a Peripheral Component Interconnect (PCI) interconnect, or an interconnect such as a PCI Express interconnect or another I/O interconnect. In some embodiments, one of the interconnects couples to a power control unit (PCU) 117, which may include circuitry, software, and/or firmware to perform power management operations with regard to the processors 170, 180 and/or co-processor 138. PCU 117 provides control information to a voltage regulator to cause the voltage regulator to generate the appropriate regulated voltage. PCU 117 also provides control information to control the operating voltage generated. In various embodiments, PCU 117 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 117 is illustrated as being present as logic separate from the processor 170 and/or processor 180. In other cases, PCU 117 may execute on a given one or more of cores (not shown) of processor 170 or 180. In some cases, PCU 117 may be implemented as a microcontroller (dedicated or general-purpose) or other control logic configured to execute its own dedicated power management code, sometimes referred to as P-code. In yet other embodiments, power management operations to be performed by PCU 117 may be implemented externally to a processor, such as by way of a separate power management integrated circuit (PMIC) or another component external to the processor. In yet other embodiments, power management operations to be performed by PCU 117 may be implemented within BIOS or other system software.

Various I/O devices 114 may be coupled to first interconnect 116, along with an interconnect (bus) bridge 118 which couples first interconnect 116 to a second interconnect 120. In some embodiments, one or more additional processor(s) 115, such as coprocessors, high-throughput MIC processors, GPGPU's, accelerators (such as, e.g., graphics accelerators or digital signal processing (DSP) units), field programmable gate arrays (FPGAs), or any other processor, are coupled to first interconnect 116. In some embodiments, second interconnect 120 may be a low pin count (LPC) interconnect. Various devices may be coupled to second interconnect 120 including, for example, a keyboard and/or mouse 122, communication devices 127 and a storage unit circuitry 128. Storage unit circuitry 128 may be a disk drive or other mass storage device which may include instructions/code and data 130, in some embodiments. Further, an audio I/O 124 may be coupled to second interconnect 120. Note that other architectures than the point-to-point architecture described above are possible. For example, instead of the point-to-point architecture, a system such as multiprocessor system 100 may implement a multi-drop interconnect or other such architecture.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die as the described CPU (sometimes referred to as the application core(s) or application processor(s)), the above described coprocessor, and additional functionality. Exemplary core architectures are described next, followed by descriptions of exemplary processors and computer architectures.

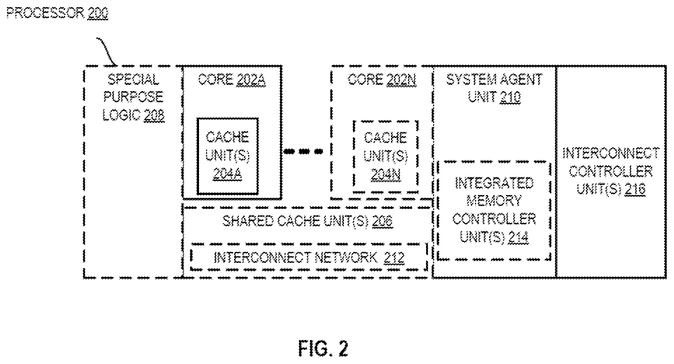

FIG. 2 illustrates a block diagram of embodiments of a processor 200 that may have more than one core, may have an integrated memory controller, and may have integrated graphics. The solid lined boxes illustrate a processor 200 with a single core 202A, a system agent 210, a set of one or more interconnect controller units circuitry 216, while the optional addition of the dashed lined boxes illustrates an alternative processor 200 with multiple cores 202(A)-(N), a set of one or more integrated memory controller unit(s) circuitry 214 in the system agent unit circuitry 210, and special purpose logic 208, as well as a set of one or more interconnect controller units circuitry 216. Note that the processor 200 may be one of the processors 170 or 180, or co-processor 138 or 115 of FIG. 1.

Thus, different implementations of the processor 200 may include: 1) a CPU with the special purpose logic 208 being integrated graphics and/or scientific (throughput) logic (which may include one or more cores, not shown), and the cores 202(A)-(N) being one or more general purpose cores (e.g., general purpose in-order cores, general purpose out-of-order cores, or a combination of the two); 2) a coprocessor with the cores 202(A)-(N) being a large number of special purpose cores intended primarily for graphics and/or scientific (throughput); and 3) a coprocessor with the cores 202(A)-(N) being a large number of general purpose in-order cores. Thus, the processor 200 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 200 may be a part of and/or may be implemented on one or more substrates using any of a number of process technologies, such as, for example, BiCMOS, CMOS, or NMOS.

A memory hierarchy includes one or more levels of cache unit(s) circuitry 204(A)-(N) within the cores 202(A)-(N), a set of one or more shared cache units circuitry 206, and external memory (not shown) coupled to the set of integrated memory controller units circuitry 214. The set of one or more shared cache units circuitry 206 may include one or more mid-level caches, such as level 2 (L2), level 3 (L3), level 4 (L4), or other levels of cache, such as a last level cache (LLC), and/or combinations thereof. While in some embodiments ring-based interconnect network circuitry 212 interconnects the special purpose logic 208 (e.g., integrated graphics logic), the set of shared cache units circuitry 206, and the system agent unit circuitry 210, alternative embodiments use any number of well-known techniques for interconnecting such units. In some embodiments, coherency is maintained between one or more of the shared cache units circuitry 206 and cores 202(A)-(N).

In some embodiments, one or more of the cores 202(A)-(N) are capable of multi-threading. The system agent unit circuitry 210 includes those components coordinating and operating cores 202(A)-(N). The system agent unit circuitry 210 may include, for example, power control unit (PCU) circuitry and/or display unit circuitry (not shown). The PCU may be or may include logic and components needed for regulating the power state of the cores 202(A)-(N) and/or the special purpose logic 208 (e.g., integrated graphics logic). The display unit circuitry is for driving one or more externally connected displays.

The cores 202(A)-(N) may be homogenous or heterogeneous in terms of architecture instruction set; that is, two or more of the cores 202(A)-(N) may be capable of executing the same instruction set, while other cores may be capable of executing only a subset of that instruction set or a different instruction set.

### Exemplary Core Architectures

### In-Order and Out-of-Order Core Block Diagram

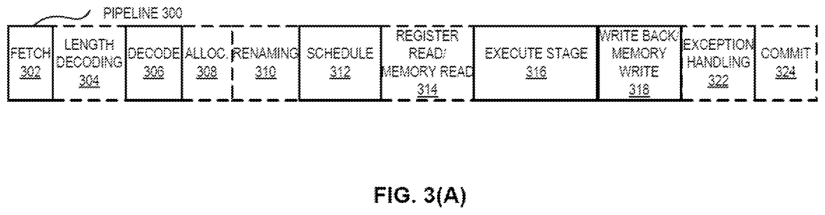

FIG. 3(A) is a block diagram illustrating both an exemplary in-order pipeline and an exemplary register renaming, out-of-order issue/execution pipeline according to embodiments of the invention. FIG. 3(B) is a block diagram illustrating both an exemplary embodiment of an in-order architecture core and an exemplary register renaming, out-of-order issue/execution architecture core to be included in a processor according to embodiments of the invention. The solid lined boxes in FIGS. 3(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 3(A), a processor pipeline 300 includes a fetch stage 302, an optional length decode stage 304, a decode stage 306, an optional allocation stage 308, an optional renaming stage 310, a scheduling (also known as a dispatch or issue) stage 312, an optional register read/memory read stage 314, an execute stage 316, a write back/memory write stage 318, an optional exception handling stage 322, and an optional commit stage 324. One or more operations can be performed in each of these processor pipeline stages. For example, during the fetch stage 302, one or more instructions are fetched from instruction memory, during the decode stage 306, the one or more fetched instructions may be decoded, addresses (e.g., load store unit (LSU) addresses) using forwarded register ports may be generated, and branch forwarding (e.g., immediate offset or an link register (LR)) may be performed. In one embodiment, the decode stage 306 and the register read/memory read stage 314 may be combined into one pipeline stage. In one embodiment, during the execute stage 316, the decoded instructions may be executed, LSU address/data pipelining to an Advanced Microcontroller Bus (AHB) interface may be performed, multiply and add operations may be performed, arithmetic operations with branch results may be performed, etc.

By way of example, the exemplary register renaming, out-of-order issue/execution core architecture may implement the pipeline 300 as follows: 1) the instruction fetch 338 performs the fetch and length decoding stages 302 and 304; 2) the decode unit circuitry 340 performs the decode stage 306; 3) the rename/allocator unit circuitry 352 performs the allocation stage 308 and renaming stage 310; 4) the scheduler unit(s) circuitry 356 performs the schedule stage 312; 5) the physical register file(s) unit(s) circuitry 358 and the memory unit circuitry 370 perform the register read/memory read stage 314; the execution cluster 360 perform the execute stage 316; 6) the memory unit circuitry 370 and the physical register file(s) unit(s) circuitry 358 perform the write back/memory write stage 318; 7) various units (unit circuitry) may be involved in the exception handling stage 322; and 8) the retirement unit circuitry 354 and the physical register file(s) unit(s) circuitry 358 perform the commit stage 324.

FIG. 3(B) shows processor core 390 including front-end unit circuitry 330 coupled to an execution engine unit circuitry 350, and both are coupled to a memory unit circuitry 370. The core 390 may be a reduced instruction set computing (RISC) core, a complex instruction set computing (CISC) core, a very long instruction word (VLIW) core, or a hybrid or alternative core type. As yet another option, the core 390 may be a special-purpose core, such as, for example, a network or communication core, compression engine, coprocessor core, general purpose computing graphics processing unit (GPGPU) core, graphics core, or the like.

The front end unit circuitry 330 may include branch prediction unit circuitry 332 coupled to an instruction cache unit circuitry 334, which is coupled to an instruction translation lookaside buffer (TLB) 336, which is coupled to instruction fetch unit circuitry 338, which is coupled to decode unit circuitry 340. In one embodiment, the instruction cache unit circuitry 334 is included in the memory unit circuitry 370 rather than the front-end unit circuitry 330. The decode unit circuitry 340 (or decoder) may decode instructions, and generate as an output one or more micro-operations, micro-code entry points, microinstructions, other instructions, or other control signals, which are decoded from, or which otherwise reflect, or are derived from, the original instructions. The decode unit circuitry 340 may further include an address generation unit circuitry (AGU, not shown). In one embodiment, the AGU generates an LSU address using forwarded register ports, and may further perform branch forwarding (e.g., immediate offset branch forwarding, LR register branch forwarding, etc.). The decode unit circuitry 340 may be implemented using various different mechanisms. Examples of suitable mechanisms include, but are not limited to, look-up tables, hardware implementations, programmable logic arrays (PLAs), microcode read only memories (ROMs), etc. In one embodiment, the core 390 includes a microcode ROM (not shown) or other medium that stores microcode for certain macroinstructions (e.g., in decode unit circuitry 340 or otherwise within the front end unit circuitry 330). In one embodiment, the decode unit circuitry 340 includes a micro-operation (micro-op) or operation cache (not shown) to hold/cache decoded operations, micro-tags, or micro-operations generated during the decode or other stages of the processor pipeline 300. The decode unit circuitry 340 may be coupled to rename/allocator unit circuitry 352 in the execution engine unit circuitry 350.

The execution engine circuitry 350 includes the rename/allocator unit circuitry 352 coupled to a retirement unit circuitry 354 and a set of one or more scheduler(s) circuitry 356. The scheduler(s) circuitry 356 represents any number of different schedulers, including reservations stations, central instruction window, etc. In some embodiments, the scheduler(s) circuitry 356 can include arithmetic logic unit (ALU) scheduler/scheduling circuitry, ALU queues, arithmetic generation unit (AGU) scheduler/scheduling circuitry, AGU queues, etc. The scheduler(s) circuitry 356 is coupled to the physical register file(s) circuitry 358. Each of the physical register file(s) circuitry 358 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one embodiment, the physical register file(s) unit circuitry 358 includes vector registers unit circuitry, writemask registers unit circuitry, and scalar register unit circuitry. These register units may provide architectural vector registers, vector mask registers, general-purpose registers, etc. The physical register file(s) unit(s) circuitry 358 is overlapped by the retirement unit circuitry 354 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 354 and the physical register file(s) circuitry 358 are coupled to the execution cluster(s) 360. The execution cluster(s) 360 includes a set of one or more execution units circuitry 362 and a set of one or more memory access circuitry 364. The execution units circuitry 362 may perform various arithmetic, logic, floating-point or other types of operations (e.g., shifts, addition, subtraction, multiplication) and on various types of data (e.g., scalar floating-point, packed integer, packed floating-point, vector integer, vector floating-point). While some embodiments may include a number of execution units or execution unit circuitry dedicated to specific functions or sets of functions, other embodiments may include only one execution unit circuitry or multiple execution units/execution unit circuitry that all perform all functions. The scheduler(s) circuitry 356, physical register file(s) unit(s) circuitry 358, and execution cluster(s) 360 are shown as being possibly plural because certain embodiments create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) unit circuitry, and/or execution cluster—and in the case of a separate memory access pipeline, certain embodiments are implemented in which only the execution cluster of this pipeline has the memory access unit(s) circuitry 364). It should also be understood that where separate pipelines are used, one or more of these pipelines may be out-of-order issue/execution and the rest in-order.

In some embodiments, the execution engine unit circuitry 350 may perform load store unit (LSU) address/data pipelining to an Advanced Microcontroller Bus (AHB) interface (not shown), and address phase and writeback, data phase load, store, and branches.

The set of memory access circuitry 364 is coupled to the memory unit circuitry 370, which includes data TLB unit circuitry 372 coupled to a data cache circuitry 374 coupled to a level 2 (L2) cache circuitry 376. In one exemplary embodiment, the memory access units circuitry 364 may include a load unit circuitry, a store address unit circuit, and a store data unit circuitry, each of which is coupled to the data TLB circuitry 372 in the memory unit circuitry 370. The instruction cache circuitry 334 is further coupled to a level 2 (L2) cache unit circuitry 376 in the memory unit circuitry 370. In one embodiment, the instruction cache 334 and the data cache 374 are combined into a single instruction and data cache (not shown) in L2 cache unit circuitry 376, a level 3 (L3) cache unit circuitry (not shown), and/or main memory. The L2 cache unit circuitry 376 is coupled to one or more other levels of cache and eventually to a main memory.

The core 390 may support one or more instructions sets (e.g., the x86 instruction set (with some extensions that have been added with newer versions); the MIPS instruction set; the ARM instruction set (with optional additional extensions such as NEON)), including the instruction(s) described herein. In one embodiment, the core 390 includes logic to support a packed data instruction set extension (e.g., AVX1, AVX2), thereby allowing the operations used by many multimedia applications to be performed using packed data.

### Exemplary Execution Unit(s) Circuitry

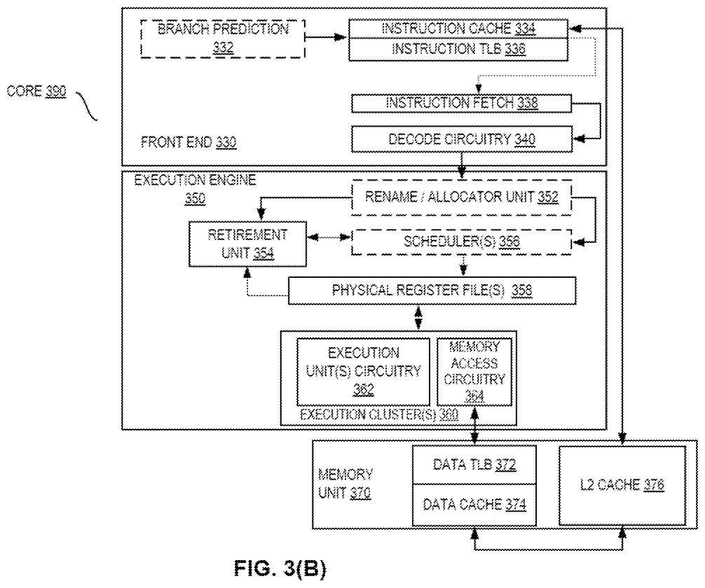

FIG. 4 illustrates embodiments of execution unit(s) circuitry, such as execution unit(s) circuitry 362 of FIG. 3(B). As illustrated, execution unit(s) circuitry 362 may include one or more ALU circuits 401, vector/SIMD unit circuits 403, load/store unit circuits 405, and/or branch/jump unit circuits 407. ALU circuits 401 perform integer arithmetic and/or Boolean operations. Vector/SIMD unit circuits 403 perform vector/SIMD operations on packed data (such as SIMD/vector registers). Load/store unit circuits 405 execute load and store instructions to load data from memory into registers or store from registers to memory. Load/store unit circuits 405 may also generate addresses. Branch/jump unit circuits 407 cause a branch or jump to a memory address depending on the instruction. Floating-point unit (FPU) circuits 409 perform floating-point arithmetic. The width of the execution unit(s) circuitry 362 varies depending upon the embodiment and can range from 16-bit to 1,024-bit. In some embodiments, two or more smaller execution units are logically combined to form a larger execution unit (e.g., two 128-bit execution units are logically combined to form a 256-bit execution unit).

### Exemplary Register Architecture

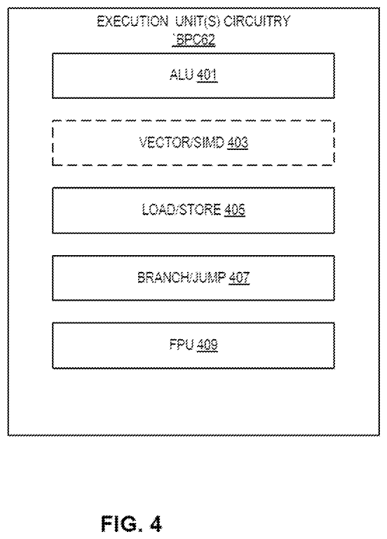

FIG. 5 is a block diagram of a register architecture 500 according to some embodiments. As illustrated, there are vector/SIMD registers 510 that vary from 128-bit to 1,024 bits width. In some embodiments, the vector/SIMD registers 510 are physically 512-bits and, depending upon the mapping, only some of the lower bits are used. For example, in some embodiments, the vector/SIMD registers 510 are ZMM registers which are 512 bits: the lower 256 bits are used for YMM registers and the lower 128 bits are used for XMM registers. As such, there is an overlay of registers. In some embodiments, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the embodiment.

In some embodiments, the register architecture 500 includes writemask/predicate registers 515. For example, in some embodiments, there are 8 writemask/predicate registers (sometimes called k0 through k7) that are each 16-bit, 32-bit, 64-bit, or 128-bit in size. Writemask/predicate registers 515 may allow for merging (e.g., allowing any set of elements in the destination to be protected from updates during the execution of any operation) and/or zeroing (e.g., zeroing vector masks allow any set of elements in the destination to be zeroed during the execution of any operation). In some embodiments, each data element position in a given writemask/predicate register 515 corresponds to a data element position of the destination. In other embodiments, the writemask/predicate registers 515 are scalable and consists of a set number of enable bits for a given vector element (e.g., 8 enable bits per 64-bit vector element).

The register architecture 500 includes a plurality of general-purpose registers 525. These registers may be 16-bit, 32-bit, 64-bit, etc. and can be used for scalar operations. In some embodiments, these registers are referenced by the names RAX, RBX, RCX, RDX, RBP, RSI, RDI, RSP, and R8 through R15.

In some embodiments, the register architecture 500 includes scalar floating-point register 545 which is used for scalar floating-point operations on 32/64/80-bit floating-point data using the x87 instruction set extension or as MMX registers to perform operations on 64-bit packed integer data, as well as to hold operands for some operations performed between the MMX and XMM registers.

One or more flag registers 540 (e.g., EFLAGS, RFLAGS, etc.) store status and control information for arithmetic, compare, and system operations. For example, the one or more flag registers 540 may store condition code information such as carry, parity, auxiliary carry, zero, sign, and overflow. In some embodiments, the one or more flag registers 540 are called program status and control registers.

Segment registers 520 contain segment points for use in accessing memory. In some embodiments, these registers are referenced by the names CS, DS, SS, ES, FS, and GS.

Machine specific registers (MSRs) 535 control and report on processor performance. Most MSRs 535 handle system-related functions and are not accessible to an application program. Machine check registers 560 consist of control, status, and error reporting MSRs that are used to detect and report on hardware errors.

One or more instruction pointer register(s) 530 store an instruction pointer value. Control register(s) 555 (e.g., CR0-CR4) determine the operating mode of a processor (e.g., processor 170, 180, 138, 115, and/or 200) and the characteristics of a currently executing task. Debug registers 550 control and allow for the monitoring of a processor or core's debugging operations.

Memory management registers 565 specify the locations of data structures used in protected mode memory management. These registers may include a GDTR, IDRT, task register, and a LDTR register.

Alternative embodiments of the invention may use wider or narrower registers. Additionally, alternative embodiments of the invention may use more, less, or different register files and registers.

### Instruction Sets

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands.

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

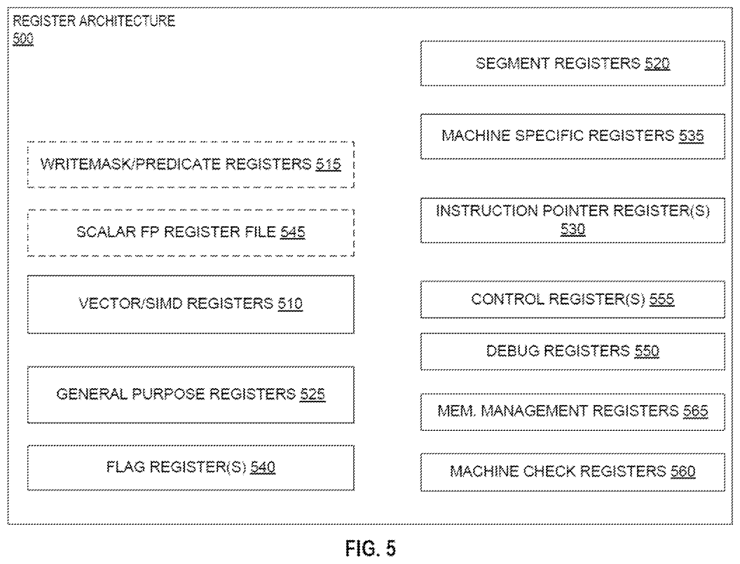

FIG. 6 illustrates embodiments of an instruction format. As illustrated, an instruction may include multiple components including, but not limited to, one or more fields for: one or more prefixes 601, an opcode 603, addressing information 605 (e.g., register identifiers, memory addressing information, etc.), a displacement value 607, and/or an immediate 609. Note that some instructions utilize some or all of the fields of the format whereas others may only use the field for the opcode 603. In some embodiments, the order illustrated is the order in which these fields are to be encoded, however, it should be appreciated that in other embodiments these fields may be encoded in a different order, combined, etc.

The prefix(es) field(s) 601, when used, modifies an instruction. In some embodiments, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 603 is used to at least partially define the operation to be performed upon a decoding of the instruction. In some embodiments, a primary opcode encoded in the opcode field 603 is 1, 2, or 3 bytes in length. In other embodiments, a primary opcode can be a different length. An additional 3-bit opcode field is sometimes encoded in another field.

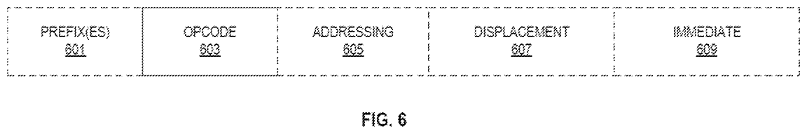

The addressing field 605 is used to address one or more operands of the instruction, such as a location in memory or one or more registers. FIG. 7 illustrates embodiments of the addressing field 605. In this illustration, an optional ModR/M byte 702 and an optional Scale, Index, Base (SIB) byte 704 are shown. The ModR/M byte 702 and the SIB byte 704 are used to encode up to two operands of an instruction, each of which is a direct register or effective memory address. Note that each of these fields are optional in that not all instructions include one or more of these fields. The MOD R/M byte 702 includes a MOD field 742, a register field 744, and R/M field 746.

The content of the MOD field 742 distinguishes between memory access and non-memory access modes. In some embodiments, when the MOD field 742 has a value of b11, a register-direct addressing mode is utilized, and otherwise register-indirect addressing is used.

The register field 744 may encode either the destination register operand or a source register operand, or may encode an opcode extension and not be used to encode any instruction operand. The content of register index field 744, directly or through address generation, specifies the locations of a source or destination operand (either in a register or in memory). In some embodiments, the register field 744 is supplemented with an additional bit from a prefix (e.g., prefix 601) to allow for greater addressing.

The R/M field 746 may be used to encode an instruction operand that references a memory address, or may be used to encode either the destination register operand or a source register operand. Note the R/M field 746 may be combined with the MOD field 742 to dictate an addressing mode in some embodiments.

The SIB byte 704 includes a scale field 752, an index field 754, and a base field 756 to be used in the generation of an address. The scale field 752 indicates scaling factor. The index field 754 specifies an index register to use. In some embodiments, the index field 754 is supplemented with an additional bit from a prefix (e.g., prefix 601) to allow for greater addressing. The base field 756 specifies a base register to use. In some embodiments, the base field 756 is supplemented with an additional bit from a prefix (e.g., prefix 601) to allow for greater addressing. In practice, the content of the scale field 752 allows for the scaling of the content of the index field 754 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some embodiments, a displacement field 607 provides this value. Additionally, in some embodiments, a displacement factor usage is encoded in the MOD field of the addressing field 605 that indicates a compressed displacement scheme for which a displacement value is calculated by multiplying disp8 in conjunction with a scaling factor N that is determined based on the vector length, the value of a b bit, and the input element size of the instruction. The displacement value is stored in the displacement field 607.

In some embodiments, an immediate field 609 specifies an immediate for the instruction. An immediate may be encoded as a 1-byte value, a 2-byte value, a 4-byte value, etc.

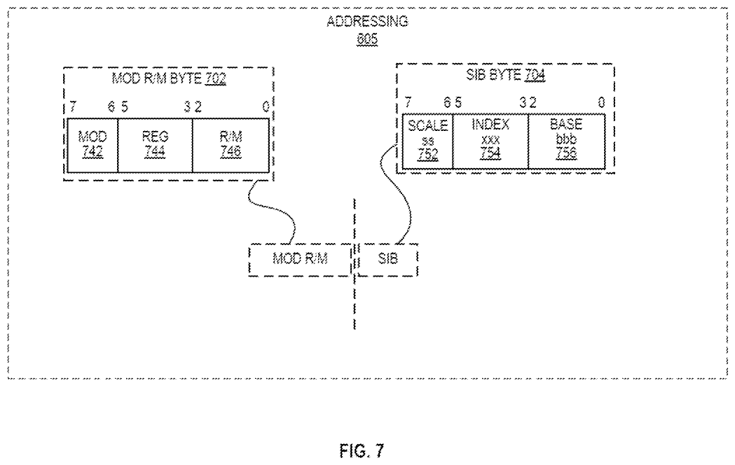

FIG. 8 illustrates embodiments of a first prefix 601(A). In some embodiments, the first prefix 601(A) is an embodiment of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 601(A) may specify up to three registers using 3-bit fields depending on the format: 1) using the reg field 744 and the R/M field 746 of the Mod R/M byte 702; 2) using the Mod R/M byte 702 with the SIB byte 704 including using the reg field 744 and the base field 756 and index field 754; or 3) using the register field of an opcode.

In the first prefix 601(A), bit positions 7:4 are set as 0100. Bit position 3 (W) can be used to determine the operand size, but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 744 and MOD R/M R/M field 746 alone can each only address 8 registers.

In the first prefix 601(A), bit position 2 (R) may an extension of the MOD R/M reg field 744 and may be used to modify the ModR/M reg field 744 when that field encodes a general purpose register, a 64-bit packed data register (e.g., a SSE register), or a control or debug register. R is ignored when Mod R/M byte 702 specifies other registers or defines an extended opcode.

Bit position 1 (X) X bit may modify the SIB byte index field 754.

Bit position B (B) B may modify the base in the Mod R/M R/M field 746 or the SIB byte base field 756; or it may modify the opcode register field used for accessing general purpose registers (e.g., general purpose registers 525).

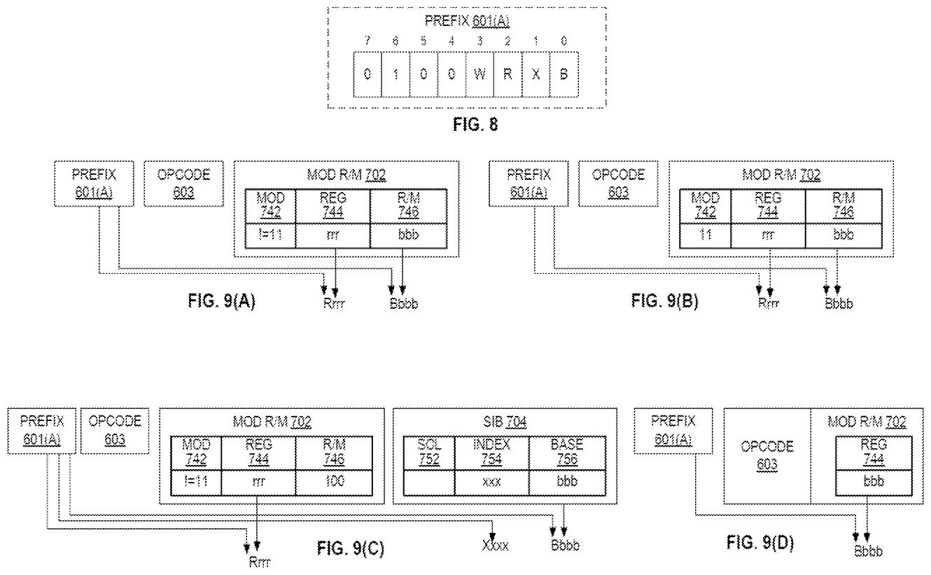

FIGS. 9(A)-(D) illustrate embodiments of how the R, X, and B fields of the first prefix 601(A) are used. FIG. 9(A) illustrates R and B from the first prefix 601(A) being used to extend the reg field 744 and R/M field 746 of the MOD R/M byte 702 when the SIB byte 7 04 is not used for memory addressing. FIG. 9(B) illustrates R and B from the first prefix 601(A) being used to extend the reg field 744 and R/M field 746 of the MOD R/M byte 702 when the SIB byte 7 04 is not used (register-register addressing). FIG. 9 (C) illustrates R, X, and B from the first prefix 601(A) being used to extend the reg field 744 of the MOD R/M byte 702 and the index field 754 and base field 756 when the SIB byte 7 04 being used for memory addressing. FIG. 9 (D) illustrates B from the first prefix 601(A) being used to extend the reg field 744 of the MOD R/M byte 702 when a register is encoded in the opcode 603.

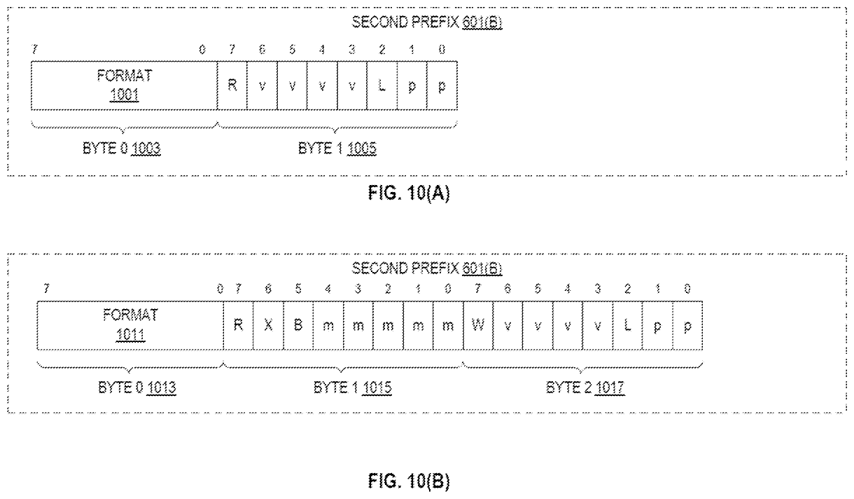

FIGS. 10(A)-(B) illustrate embodiments of a second prefix 601(B). In some embodiments, the second prefix 601(B) is an embodiment of a VEX prefix. The second prefix 601(B) encoding allows instructions to have more than two operands, and allows SIMD vector registers (e.g., vector/SIMD registers 510) to be longer than 64-bits (e.g., 128-bit and 256-bit). The use of the second prefix 601(B) provides for three-operand (or more) syntax. For example, previous two-operand instructions performed operations such as A=A+B, which overwrites a source operand. The use of the second prefix 601(B) enables operands to perform nondestructive operations such as A=B+C.

In some embodiments, the second prefix 601(B) comes in two forms-a two-byte form and a three-byte form. The two-byte second prefix 601(B) is used mainly for 128-bit, scalar, and some 256-bit instructions; while the three-byte second prefix 601(B) provides a compact replacement of the first prefix 601(A) and 3-byte opcode instructions.

FIG. 10(A) illustrates embodiments of a two-byte form of the second prefix 601(B). In one example, a format field 1001 (byte 0 1003) contains the value C5H. In one example, byte 1 1005 includes a “R” value in bit[7]. This value is the complement of the same value of the first prefix 601(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1 s complement form for certain vector shifts; or 3) not encode any operand, the field is reserved and should contain a certain value, such as 1111b.

Instructions that use this prefix may use the Mod R/M R/M field 746 to encode the instruction operand that references a memory address or encode either the destination register operand or a source register operand.

Instructions that use this prefix may use the Mod R/M reg field 744 to encode either the destination register operand or a source register operand, be treated as an opcode extension and not used to encode any instruction operand.

For instruction syntax that support four operands, vvvv, the Mod R/M R/M field 746 and the Mod R/M reg field 744 encode three of the four operands. Bits[7:4] of the immediate 609 are then used to encode the third source register operand.

FIG. 10(B) illustrates embodiments of a three-byte form of the second prefix 601(B). in one example, a format field 1011 (byte 0 1013) contains the value C4H. Byte 1 1015 includes in bits[7:5] “R,” “X,” and “B” which are the complements of the same values of the first prefix 601(A). Bits[4:0] of byte 1 1015 (shown as mmmmm) include content to encode, as need, one or more implied leading opcode bytes. For example, 00001 implies a 0FH leading opcode, 00010 implies a 0F38H leading opcode, 00011 implies a leading 0F3AH opcode, etc.

Bit[7] of byte 2 1017 is used similar to W of the first prefix 601(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 746 to encode the instruction operand that references a memory address or encode either the destination register operand or a source register operand.

Instructions that use this prefix may use the Mod R/M reg field 744 to encode either the destination register operand or a source register operand, be treated as an opcode extension and not used to encode any instruction operand.

For instruction syntax that support four operands, vvvv, the Mod R/M R/M field 746, and the Mod R/M reg field 744 encode three of the four operands. Bits[7:4] of the immediate 609 are then used to encode the third source register operand.

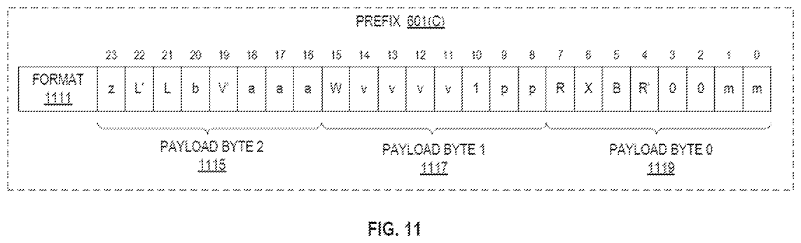

FIG. 11 illustrates embodiments of a third prefix 601(C). In some embodiments, the first prefix 601(A) is an embodiment of an EVEX prefix. The third prefix 601(C) is a four-byte prefix.

The third prefix 601(C) can encode 32 vector registers (e.g., 128-bit, 256-bit, and 512-bit registers) in 64-bit mode. In some embodiments, instructions that utilize a writemask/opmask (see discussion of registers in a previous figure, such as FIG. 5) or predication utilize this prefix. Opmask register allow for conditional processing or selection control. Opmask instructions, whose source/destination operands are opmask registers and treat the content of an opmask register as a single value, are encoded using the second prefix 601(B).

The third prefix 601(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 601(C) is a format field 1111 that has a value, in one example, of 62H. Subsequent bytes are referred to as payload bytes 1115-1119 and collectively form a 24-bit value of P[23:0] providing specific capability in the form of one or more fields (detailed herein).

In some embodiments, P[1:0] of payload byte 1119 are identical to the low two mmmmm bits. P[3:2] are reserved in some embodiments. Bit P[4] (R′) allows access to the high 16 vector register set when combined with P[7] and the ModR/M reg field 744. P[6] can also provide access to a high 16 vector register when SIB-type addressing is not needed. P[7:5] consist of an R, X, and B which are operand specifier modifier bits for vector register, general purpose register, memory addressing and allow access to the next set of 8 registers beyond the low 8 registers when combined with the ModR/M register field 744 and ModR/M R/M field 746. P[9:8] provide opcode extensionality equivalent to some legacy prefixes (e.g., 00=no prefix, 01=66H, 10=F3H, and 11=F2H). P[10] in some embodiments is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 601(A) and second prefix 611(B) and may serve as an opcode extension bit or operand size promotion.

P[18:16] specify the index of a register in the opmask (writemask) registers (e.g., writemask/predicate registers 515). In one embodiment of the invention, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While embodiments of the invention are described in which the opmask field's content selects one of a number of opmask registers that contains the opmask to be used (and thus the opmask field's content indirectly identifies that masking to be performed), alternative embodiments instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Exemplary embodiments of encoding of registers in instructions using the third prefix 601(C) are detailed in the following tables.

TABLE 1
32-Register Support in 64-bit Mode

| | | | | REG. | COMMON |
|---|---|---|---|---|---|
| | 4 | 3 | [2:0] | TYPE | USAGES |
| REG | R′ | R | ModR/M | GPR, | Destination |
| | | | reg | Vector | or Source |
| VVVV | V′ | vvvv | | GPR, | 2nd Source or |
| | | | | Vector | Destination |
| RM | X | B | ModR/M | GPR, | 1st Source or |
| | | | R/M | Vector | Destination |
| BASE | 0 | B | ModR/M | GPR | Memory |
| | | | R/M | | addressing |
| INDEX | 0 | X | SIB.index | GPR | Memory |
| | | | | | addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | ModR/M reg | GPR, Vector | Destination or Source |
| VVVV | vvvv | GPR, Vector | 2^{nd} Source or Destination |
| RM | ModR/M R/M | GPR, Vector | 1^{st} Source or Destination |
| BASE | ModR/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | | REG. | COMMON |
|---|---|---|---|
| | [2:0] | TYPE | USAGES |
| REG | ModR/M Reg | k0-k7 | Source |
| VVVV | vvvv | k0-k7 | 2^{nd} Source |
| RM | ModR/M R/M | k0-7 | 1^{st} Source |
| {k1] | aaa | k0¹-k7 | Opmask |

Program code may be applied to input instructions to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

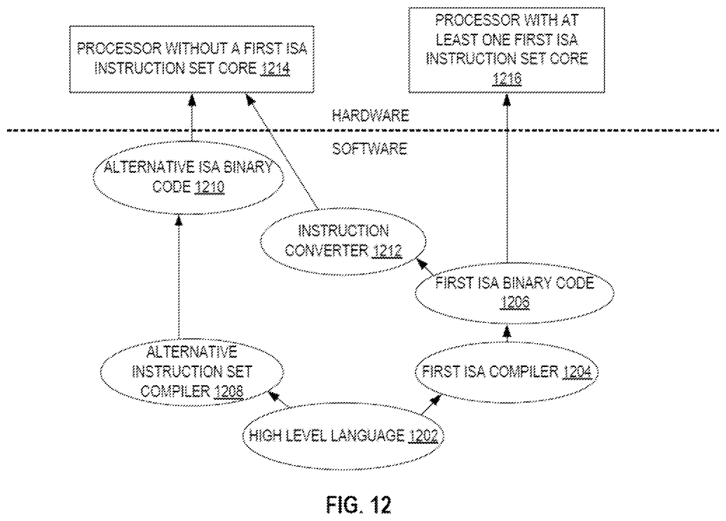

FIG. 12 illustrates a block diagram contrasting the use of a software instruction converter to convert binary instructions in a source instruction set to binary instructions in a target instruction set according to certain implementations. In the illustrated embodiment, the instruction converter is a software instruction converter, although alternatively the instruction converter may be implemented in software, firmware, hardware, or various combinations thereof. FIG. 12 shows a program in a high level language 1202 may be compiled using a first ISA compiler 1204 to generate first ISA binary code 1206 that may be natively executed by a processor with at least one first instruction set core 1216. The processor with at least one first ISA instruction set core 1216 represents any processor that can perform substantially the same functions as an Intel® processor with at least one first ISA instruction set core by compatibly executing or otherwise processing (1) a substantial portion of the instruction set of the first ISA instruction set core or (2) object code versions of applications or other software targeted to run on an Intel processor with at least one first ISA instruction set core, in order to achieve substantially the same result as a processor with at least one first ISA instruction set core. The first ISA compiler 1204 represents a compiler that is operable to generate first ISA binary code 1206 (e.g., object code) that can, with or without additional linkage processing, be executed on the processor with at least one first ISA instruction set core 1216.

Similarly, FIG. 12 shows the program in the high level language 1202 may be compiled using an alternative instruction set compiler 1208 to generate alternative instruction set binary code 1210 that may be natively executed by a processor without a first ISA instruction set core 1214. The instruction converter 1212 is used to convert the first ISA binary code 1206 into code that may be natively executed by the processor without a first ISA instruction set core 1214. This converted code is not likely to be the same as the alternative instruction set binary code 1210 because an instruction converter capable of this is difficult to make; however, the converted code will accomplish the general operation and be made up of instructions from the alternative instruction set. Thus, the instruction converter 1212 represents software, firmware, hardware, or a combination thereof that, through emulation, simulation or any other process, allows a processor or other electronic device that does not have a first ISA instruction set processor or core to execute the first ISA binary code 1206.

### Apparatus and Method for High Performance Near-Memory Atomic Operations in a Distributed Memory System

Atomic operations—such as a load, operate, and store sequence which must occur before the next memory access—are critical tools for software in many different scenarios. In multi-threaded architectures ranging in scale from one thread to many threads, atomic operations are used to facilitate thread synchronization via atomic increments to a global counter or assist in load balancing using atomics to properly claim the locks for tasks.

For example, graph analytics—a sparse domain with datasets quickly growing to the order of Petabytes—utilizes atomic operations in many workloads. Graph search algorithms require atomic operations to mark visited vertices using compare-exchange semantics (e.g., atomically claim the current vertex if it does not have an owner ID). Other sparse use cases that can utilize highly-performant atomics include hash table insertion/deletion and pushing updates to neighboring vertices' importance values in the PageRank algorithm.

With increases in dataset and system sizes, the architectural approaches to most efficiently solving problems like sparse graph analytics change. The Programmable Integrated Unified Memory Architecture (PIUMA) is designed for graph analytics and combines highly-multithreaded cores with a scalable network to support systems of O(100) nodes with O(1M) threads. PIUMA uses a distributed global address space (DGAS), allowing for any thread to access any memory endpoint in a system that provides both cached (with limited coherency) and un-cached operations. Systems of this size require atomic operations for basic multithreaded functionality, but are likely performance-constrained using preexisting solutions.

Prior hardware approaches include load linked and store conditional instructions to monitor the memory location under operation. This is done by first placing the memory address in a link register when the load linked instruction is called. Then, if the cache line is invalidated or an interrupt is triggered, the link register is cleared. Once the store conditional operation occurs at the end of the atomic operation, the link register is checked. If the linked register has changed, the store will fail, and the atomic read-modify-write will need to be retried. This approach works well when the memory location is cached in a coherent domain, and the line can be monitored in the local cache for invalidations. However, large-scale systems with limited (or software managed) coherency, will require alternative line-lock monitoring approaches. Additionally, the added latency of the coherency protocol limits the total performance of these operations, especially under scenarios with high contention.

Some embodiments described below perform efficient read-lock/write-unlock handling including a local retry mechanism at the near-memory unit for near-peak throughput for both contended and non-contended use-cases. As described below, implementations include new instructions, pipeline handling of these offloaded operations, and design of the atomic unit (ATMU) and line-lock manager near each memory interface, including memory interfaces for DRAM, local/scratchpad memory, and registers (e.g., MSRs).

Support for at-speed remote atomic operations in a non-cached distributed memory system results in significant performance improvements to many future sparse workloads. The performance benefits will only increase as system scale and thread counts increase, as the cost of synchronization and shared variables will decrease without the cost of lock management near the cores.

While the instructions and architectural details are described below for remote atomic operations in PIUMA, the underlying principles of the invention are not limited to PIUMA and may be implemented in other distributed memory architectures with remote atomics.

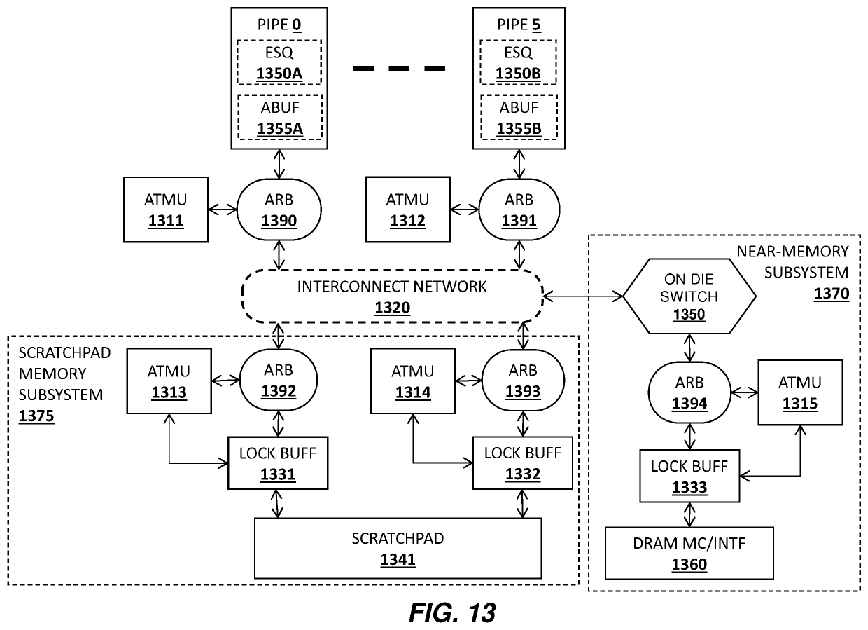

FIG. 13 illustrates an example of a Programmable Integrated Unified Memory Architecture (PIUMA) core with six pipelines 0-5 (only two of which are shown for simplicity). Some implementations may include a number of these cores per die (e.g., four, eight, sixteen, etc). The illustrated architecture scales to O(1000) nodes with all memory endpoints visible via a 64-bit distributed global address space (DGAS). Storage includes a 4 MB (2-port) scratchpad memory 1341 (e.g., a static random access memory (SRAM)) within a scratchpad memory subsystem 1375 and an adjacent narrow-channel (8B) DRAM interface/memory controller 1360 (e.g., operable at 4 GB/core) within a near-memory subsystem 1370, while model-specific registers (MSRs) and physical register files (PRFs) may also be targeted by any pipeline. Although not illustrated, embodiments of the invention may be used within various other levels of memory such as storage class or “far” memory (not shown).

In some embodiments, atomic unit (ATMU) engines 1311-1315, positioned in multiple locations handle the execution of the atomic operation next to the memory interface. Each ATMU engine 1311-1315 includes one or more integer units and one or more floating-point units and may support execution of multiple instructions in parallel to maintain high throughput.

In some implementations, lock buffers 1331-1333 maintain line-lock status for memory addresses behind the scratchpad 1341 and DRAM port 1360. The lock buffers 1331-1333 are multi-entry buffers that allow for multiple locked addresses in parallel per memory interface, handle partial line updates and write-combining for partial stores, and support ‘read-lock’ and ‘write-unlock’ requests within atomics. Requests of different sizes are supported, such as 64B or 8B requests as described in detail below. Arbitration units 1390-1393 control access to the high-speed interconnect network 1320 which interconnects the core pipelines 0-5 to the scratchpad memory 1341, ATMUs 1313-1314, lock buffers 1331-1332, and near memory subsystem 1370.

An on-die switch 1350 couples the near memory subsystem 1370 to the interconnect network 1320 to provide access to the DRAM memory controller/interface 1360 and the associated lock buffer 1333 and ATMU 1315 via arbitration unit 1394.

In some implementations, each pipeline 0, 5 includes an engine sequence queue (ESQ) 1350A, 1350B and an atomic buffer (ABUF) 1355A, 1355B, respectively. The ESQs 1350A-B manage the status and ordering of offloaded operations including DMA, atomics, thread context operations, and collectives. In these embodiments, each ESQ 1350A-B supports “chaining” of offloaded operations to guarantee sequential operation. The ESQs 1350A-B provide visibility of offloaded operations to each corresponding pipeline 0, 5 by implementing wait-class instructions and/or triggering interrupts upon completion of offloaded operations. The ESQs 1350A-B also allow their respective pipelines 0, 5 to track status for the purposes of fencing on offloaded operations.

The atomic buffers (ABUFs) 1355A-B are also pipeline-local units which track outstanding remote atomic requests sent from that pipeline. Each ABUF 1355A-B is responsible for committing the return value (if necessary) back to the local register file of its respective pipeline 0, 5, indicating completion to the corresponding ESQ 1350A-B, and reporting any exceptions that occur during remote atomic operations.

The remainder of this disclosure will discuss each aspect of the embodiments of the invention, including remote atomic operations, the ISA descriptions and pipeline behavior, and then the operation of the ATMUs 1313-1315 and lock buffers 1331-1333 at each respective memory interface.

Table 4 lists a set of remote atomic instructions which may be implemented by embodiments of the invention. These instructions may be provided as part of an ISA extension. Note, however, that the underlying principles of the invention do not require an implementation of these specific instructions.

For operations that include a computation, both integer and floating point types are supported via different instructions (i.e. xaddI and xaddF). These are combined into a single row of Table 4. All operation types also have three flavors of instruction input arguments to support different types of addressing. All flavors are listed, and the difference in address generation is specified in the ‘Description’ column.

The RVAL argument shown in these instructions is for the programmer to specify if a return value (e.g., to be written to a register file) is needed. If so, the instruction will become blocking when data dependencies occur within the pipeline. If not, the instruction is offloaded and executed in the background, only becoming visible if software implements a fence on atomic operations. Instructions with no RVAL (i.e. xchg) will always have a return value written to the register file. The SIZE argument specifies the target data size as 8, 16, 32, or 64 bits.

TABLE 4

| Instruction | ASM For Arguments | Description |
|---|---|---|
| xadd{I/F} | r1, r2, r3, r4, SIZE, | mem[r2+r3] += r4; if (RVAL==1), return |
| | RVAL | oldval in r1, else no return val. |
| xadd{I/F} | r1, r2, r3, SIZE, | mem[r2] += r3; if (RVAL==1), return |
| | RVAL | oldval in r1, else no return val. |
| xadd{I/F} | r1, r2, imm32, SIZE, | mem[zero_ext(imm32)] += r2; if |
| | RVAL | (RVAL==1), return oldval in r1, else no |
| | | return val. |
| xincdec{I/F} | r1, r2, r3, SIZE, | mem[r2+r3] += (INCDEC ? 1 : −1); if |
| | RVAL, INCDEC | (RVAL==1), return oldval in r1, else no |
| | | return val. |
| xincdec{I/F} | r1, r2, SIZE, | mem[r2] += (INCDEC ? 1 : −1); if |
| | RVAL, INCDEC | (RVAL==1), return oldval in r1, else no |
| | | return val. |
| xincdec{I/F} | r1, imm32, SIZE, | mem[zero_ext(imm32)] += (INCDEC ? |
| | RVAL, INCDEC | 1 : −1); if (RVAL==1), return oldval |
| | | in r1, else no return val. |
| xbitop1{I/F} | r1, r2, r3, r4, BITOP, | mem[r2+r3] BITOP r4; if (RVAL==1), |
| | SIZE, RVAL | return oldval in r1, else no return val. |
| xbitop1{I/F} | r1, r2, r3, BITOP, | mem[r2] BITOP r3; if (RVAL==1), return |
| | SIZE, RVAL | oldval in r1, else no return val. |
| xbitop1{I/F} | r1, r2, imm32, | mem[zero_ext(imm32)] BITOP r2; if |
| | BITOP, SIZE, | (RVAL==1), return oldval in r1, else no |
| | RVAL | return val. |
| xmax{I/F} | r1, r2, r3, r4, SIZE, | max(mem[r2+r3], r4); if (RVAL==1), |
| | RVAL | return oldval in r1, else no return val. |
| xmax{I/F} | r1, r2, r3, SIZE, | max(mem[r2], r3); if (RVAL==1), return |
| | RVAL | oldval in r1, else no return val. |
| xmax{I/F} | r1, r2, imm32, | max(mem[zero_ext(imm32)], r2); if |
| | SIZE, RVAL | (RVAL==1), return oldval in r1, else no |
| | | return val. |
| xmin{I/F} | r1, r2, r3, r4, SIZE, | min(mem[r2+r3], r4); if (RVAL==1), |
| | RVAL | return oldval in r1, else no return val. |
| xmin{I/F} | r1, r2, r3, SIZE, | min(mem[r2], r3); if (RVAL==1), return |
| | RVAL | oldval in r1, else no return val. |
| xmin{I/F} | r1, r2, imm32, SIZE, | min(mem[zero_ext(imm32)], r2); if |
| | RVAL | (RVAL==1), return oldval in r1, else no |
| | | return val. |
| xchg{I/F} | r1, r2, r3, SIZE | tmp=mem[r2+r3]; mem[r2+r3]=r1; |
| | | r1=tmp |
| xchg{I/F} | r1, r2, SIZE | tmp=mem[r2]; mem[r2]=r1; r1=tmp |
| xchg{I/F} | r1, imm32, r2, SIZE | tmp=mem[r2+zero_ext(imm32)]; |
| | | mem[r2+zero_ext(imm32)]=r1; r1=tmp |
| cmpxchg{I/F} | r1, r2, r3, r4, SIZE | tmp=mem[r2+r3]; if( tmp==r4 ) then |
| | | mem[r2+r3]=r1; r1=tmp |
| cmpxchg{I/F} | r1, r2, r3SIZE | tmp=mem[r2]; if( tmp==r3 ) then |
| | | mem[r2]=r1; r1=tmp |
| cmpxchg{I/F} | r1, imm32, r2, SIZE | tmp=mem[zero_ext(imm32)]; |
| | | if( tmp==r2 ) then |
| | | mem[zero_ext(imm32)]=r1; r1=tmp |
| icmpxchg{I/F} | r1, r2, r3, r4, SIZE | tmp=mem[r2+r3]; if( tmp != r4 ) then |
| | | mem[r2+r3]=r1; r1=tmp |
| icmpxchg{I/F} | r1, r2, r3SIZE | tmp=mem[r2]; if( tmp != r3 ) then |
| | | mem[r2]=r1; r1=tmp |
| icmpxchg{I/F} | r1, imm32, r2, SIZE | tmp=mem[zero_ext(imm32)]; |
| | | if( tmp != r2 ) then |
| | | mem[zero_ext(imm32)]=r1; r1=tmp |

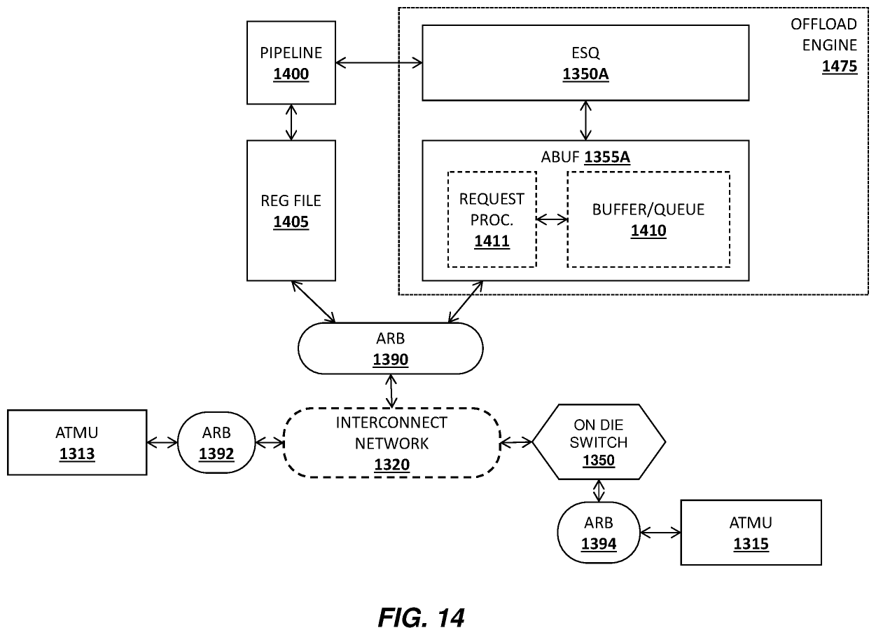

As mentioned, each Atomic Buffer (ABUF) 1355A-B is the pipeline-local unit responsible for packetizing and transmitting a remote atomic packet to the destination, tracking status of the remote atomic operations, and committing return values back to the local register file. FIG. 14 shows an example of a local pipeline 1400 and its corresponding ABUF 1355A and ESQ 1350A, which operate in combination as a memory offload engine 1475.

The process is initiated when an atomic instruction is sent from the pipeline 1400 to ESQ 1350A, which stores the instruction program counter (PC) and forwards the full instruction to the ABUF 1355A. In response, request processing logic 1411 in the ABUF 1355A allocates a slot in its internal buffer 1410 and stores the full instruction information. In some embodiments, the request processing logic 1411 reduces the request size to the minimum information required by the destination ATMU (e.g., ATMU 1313 or ATMU 1315), and sends this reduced information in a packet via its arbitration unit 1390 and interconnect network 1320.

The destination ATMU, e.g., ATMU 1313, performs the requested operations and returns a response over the interconnect network 1320. If a return value is required, the ATMU 1313 or ABUF 1355A stores the return value to the register file 1405 via arbitration unit 1390. If the register file address is locked for any reason, the request processing logic 1411 of the ABUF 1355A re-attempts to commit the results until successful. Once the results are committed, the request processing logic 1411 clears the instruction from its buffer 1410 and sends an acknowledgment to the ESQ 1350A.

Table 5 shows the storage breakdown of a single entry in the ABUF's internal queue 1410 in accordance with some embodiments. Because the ABUF 1355A serves as a staging unit for the instruction before sending it to the remote ATMU 1313, all instruction fields are maintained in the queue.

TABLE 5

| | | Width |
|---|---|---|
| Name | Description | (bits) |
| ESQ ID | ID to map ABUF storage entry to ESQ slot ID | 8 |
| RVAL | Asserted if a value will be returned to a register | 1 |
| Opcode | Atomic instruction opcode to send to ATMU | 5 |
| Address | Canonical target memory address | 64 |
| Data | Data for atomic operation | 64 |
| Exchange Data | Exchange data for cmp-exchange | 64 |
| RVAL Address | Return value local register address | 14 |

In some embodiments, the atomic packet that is issued to the network is sent with a subset of the values shown in Table 5. For example, the RVAL address may not be transmitted in the packed, as this is used only by the ABUF 1355A to store the data received at the conclusion of the operation into the local register file 1405. Therefore, in these implementations, atomic instructions other than cmp×chg and icmp×chg are sent to the remote destination with 78 bits of “instruction data” combined with the 64 bit address. The cmp×chg and icmp×chg instructions are sent with 142 bits of “instruction data.” In some embodiments, a single-flit packet can support up to 80 bits of “instruction data” on the interconnect network 1320, which means that most atomic instructions take only a single flit and can be issued and transferred at a rate of 1/cycle.

As mentioned, an atomic instruction traverses the interconnect network 1320 via one or more arbitration units 1390-1394 and arrives at the ATMU associated with the memory endpoint, such as scratchpad 1341, the DRAM interface 1360, or a specified MSR (not shown). In FIG. 13, for example, an atomic instruction sent to the near memory subsystem 1370 is diverted to the corresponding atomic unit (ATMU) 1315.

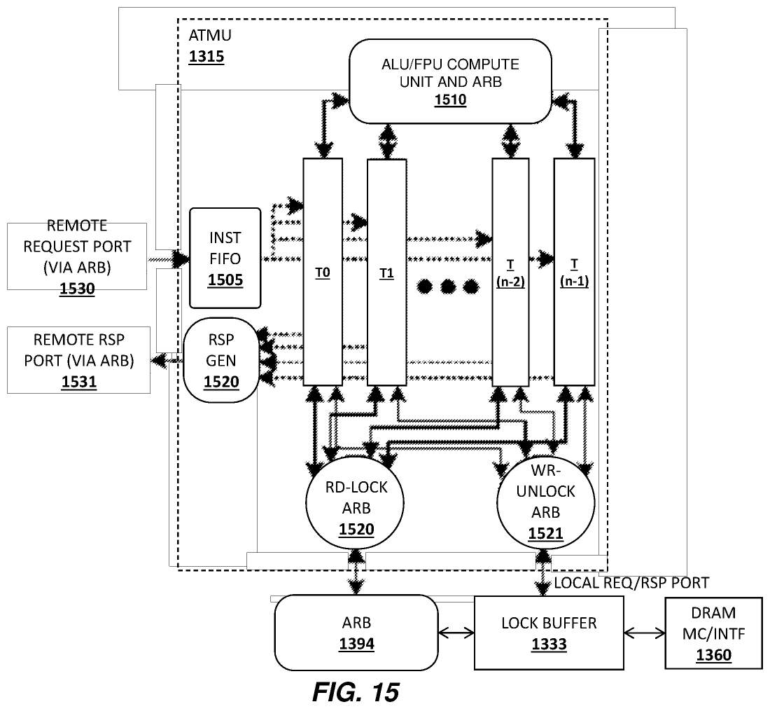

FIG. 15 illustrates an ATMU 1315 in accordance with some embodiments of the invention. Instructions received from the interconnect network 1320 over the ARB port 1530 (remote requests) are queued into an input FIFO 1505 for execution and responses 1520 are sent over the remote RSP port 1531 (also via an arbitration unit). At the front of the FIFO 1505, the instruction is assigned to one of ‘n’ parallel execution threads, T0, T1, . . . . T(n−2), T(n−1), which share access to one or more pipelined ALU/FPU units 1510 and two output ports: the output local request port 1520 through the arbitration unit 1394 to the lock buffer 1333 for ‘read-lock’ requests and the output port 1521 direct to the lock buffer 1333 for ‘write-unlock’ requests. In addition,

In operation, once the instruction packet is accepted by the ATMU 1315, the ATMU 1315 decodes the instruction and generates a ‘read-lock’ request to the local memory controller 1360 via the lock buffer 1333. The lock buffer 1333 returns the requested data and the address remains locked in the lock buffer. The ATMU 1315 then executes the operation specified by the instruction using its internal ALUs/FPUs 1510 and commits the results of the operation back to memory 1360 through the lock buffer 1333 using a ‘write-unlock’ request. The operation is complete at this point and the lock buffer 1333 unlocks the line(s). The ATMU 1315 transmits an instruction completion indication back to the source ABUF 1355A from the remote response port 1531 (which traverses the interconnect network 1320 to reach the ABUF 1355A). If a return value is requested, that data value is included in the response packet and may be written to the register file 1405. For example, a 64-bit value may be transmitted in the response packet, which the ABUF 1355A stores in the register file 1405 and notifies the ESQ 1350A of the corresponding pipeline.

The ATMU 1315 supports the highest throughput possible for executing remote atomic operations. Because the remote atomic requests can arrive at the ATMU 1315 at a rate of one per cycle, some implementations of the ATMU 1315 support the execution of at least one operation per cycle.

In some embodiments, the number (n) of execution threads, T0-T(n−1), is determined by the latency of a single atomic operation, making each ATMU instance unique in the number of execution threads that exist in each subsystem block. All other features may be consistent across the ATMUs. ATMUs in front of scratchpad ports, such as ATMUs 1313-1314 may have fewer execution threads due to the lower latency of the on-die SRAM accesses.

In some implementations, there are two memory accesses per atomic operation, which could create a bottleneck with a single port into the local memory channel. Thus, some embodiments include separate read and write ports to maintain performance expectations (e.g., 8 GB/s/op). These embodiments include support within the lock buffer as well, as described below.

Some embodiments of the ATMU perform priority ordering of nack-retried requests based on a retry-index value. Ordering of memory accesses is expected once the requests arrive at the destination memory interface. To support this expectation, when an address is locked and a subsequent access is made to that locked address, the lock buffer (e.g., lock buffer 1333) returns a “retry-index” value to the requestor. Once the line is unlocked the retried requests to that address are accepted based on the order in which they originally attempted to access the address. To preserve the bandwidth available over the request ports from the ATMU 1315, only retries that have the highest probability of success should be issued. Therefore, the ATMU 1315 is designed to account for the priority of the retry index value when issuing the retried requests.

### Apparatus and Method for Reconciling Conflicting Cacheline Modifications

As mentioned, structured programming approaches for managing global shared structures incur a significant performance penalty due to the overhead of software-managed coherency. Embodiments of the invention leverage the fact that the way data is accessed and shared for threads in different coherency islands can be viewed as a reduction type of operation. As used herein, a “reduction” operation or “reduction-type” operation can include, but is not limited to, accumulations, multiplications, add/subtract, min/max operations, and bit manipulation operations. In these cases, the order that the data is modified at the shared memory location does not matter, and the only requirement for these accesses is that the data must be atomically updated.

Embodiments of the invention include circuitry to execute remote atomic operations near the memory endpoint (e.g., within the memory controller or cache controller) to perform reduction-type operations within cache-line writebacks, which provides a significant performance gain by eliminating the write-ack visibility and inter-thread synchronization phases of software-managed coherency techniques. These embodiments may include cache islands with near-memory atomics which collaborate to perform reductions. The cache islands may be physically distributed in a system as discrete components or integrated in an SoC. The implementations described herein may be used for various types of applications including, but not limited to, graph analytics, high performance computing (HPC), dense and sparse tensors, and program code designed for reductions.

Some implementations include microarchitectural features which inform the caching subsystem of a given range of addresses in which to perform near-memory reconciliation operations. By way of example, and not limitation, the reconciliation operations can include add/subtract, multiply, min/max, and bit manipulations performed at a particular data type granularity. In these implementations, when data within the given range of addresses is written back to memory, the data existing in memory is atomically reconciled with the incoming data using the provided operator and data type granularity. Architectural features associated with the cache subsystem and near-memory remote atomic units support these operations.

Some embodiments implement a distributed global address space (DGAS) and a scalable low-diameter and high-radix network to scale up to 100K sockets in a single system. Within a socket, the compute hierarchy may include a number of tiles, T, where each tile consists of S slices, and each slice comprises M pipelines (e.g., where T=8, 16, 32, etc.; S=4, 8, 16, etc.; and M=4, 8, 16, etc.). In some implementations, the pipelines may be multiple-instruction multiple data (MIMD) pipelines such as scalar RISC-V pipelines, although the underlying principles of the invention are not limited to any particular pipeline types.

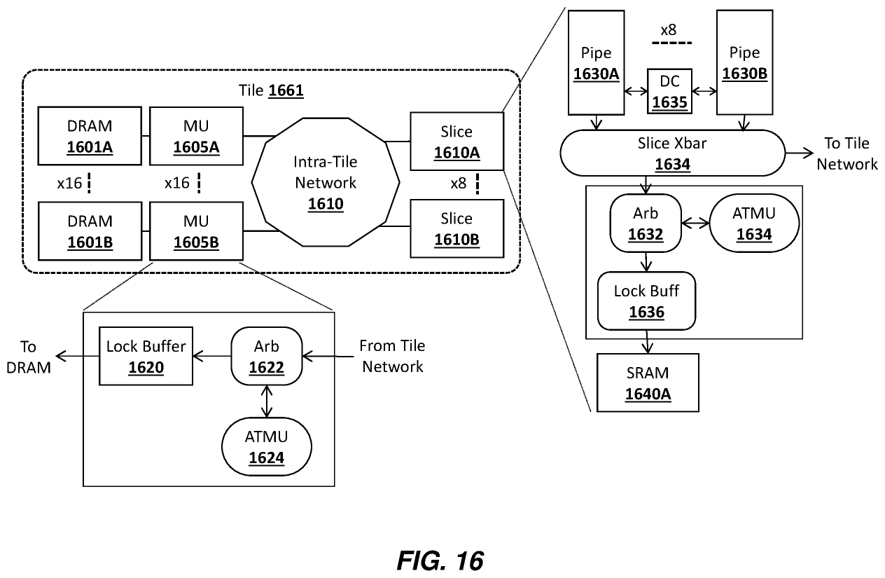

FIG. 16 illustrates one embodiment of a tile 1661 with an intra-tile network 1610 interconnecting eight slices 1610A-B, 16 memory units 1605A-B, and 16 corresponding DRAM memories 1601A-B. Slice 1610A (which is representative of all slices) includes eight MIMD (multiple-instruction multiple-data) pipelines 1630A-B coupled via a slice crossbar 1634. The combination of ATMU 1634, arbitrator 1632, and lock buffer 1636 form a memory unit as previously described to provide access to an SRAM memory 1640A (e.g., scratchpad memory subsystem 1375 in FIG. 13 with ATMU 1313 and ATMU 1314). Similarly, MU 1605B (representative of all memory units) includes an ATMU 1624, arbitrator 1622, and corresponding lock buffer 1620 which operate as previously described to provide access to DRAM 1601B (see, e.g., near-memory subsystem 1370 with ATMU 1315, arbitrator 1394, and lock buffer 1333).

One embodiment of a caching approach within the compute hierarchy is as follows. The MIMD pipelines 1630A-B within a slice 1610A share a data cache 1635, and all data caches in a tile 1661 are coherent. Tiles in a socket are not necessarily coherent due to high latency overheads as well as the expected programming approach of job and data isolation within each tile. This means that the tile 1661 is considered the coherency “island” within the system, and any shared global data structures will need additional effort towards managing concurrent accesses.

Separate from the cache subsystem are the plurality of atomic units (ATMUs) (e.g., 1624, 1634), some of which include compute-near-memory capability, as previously described. Briefly, each ATMU is configured within or near a memory interface and receives a full instruction packet with the atomic request from a pipeline 1630A-B. Each ATMU 1624, 1634 can perform integer and floating-point operations (see, e.g., FIG. 15, ALU/FPU compute unit 1510) and operates with a corresponding lock buffer 1620, 1636 to perform the atomic operations. In particular, a lock buffer 1620, 1636 is configured in front of a corresponding memory port and maintains line-lock status for memory addresses sent to the memory port. Lock buffers 1620, 1636 are multi-entry buffers that allow for multiple locked addresses in parallel per memory interface, support requests of different sizes (e.g., 64B, 8B, etc), manage partial line updates and write-combining for partial stores, and support ‘read-lock’ and ‘write-unlock’ requests within atomics.

As mentioned, in a system with multiple coherency domains, software can control the coherency of shared data structures by flushing the caches within one coherent domain and informing another coherent domain that the writes have been successfully committed to memory. This incurs performance penalties due to the communication costs (in addition to the memory accesses) between the different coherent islands. For some access patterns of the shared data, this type of control may be unavoidable. However, in some cases, the extent of the data modification from each thread is a single operation characterized as a reduction operation on a single memory location between many threads in the system.

Rather than taking the entire process of fetch the data from memory->execute the reduction at the pipeline->write the cacheline back to memory sequentially per thread, the existence of the remote atomic compute as described herein allows threads to push the reduction operation to the memory. However, having all threads bypass the cache hierarchy and emit remote atomics directly to memory results in high traffic across the network and at the memory.

The following analysis compares this remote atomic approach with a combination of local coherency and remote atomics implemented by embodiments of the invention. In a system with ‘C’ cache coherence islands each having ‘T’ threads participating in computation, if ‘N’ contributions of size ‘S’ per thread are expected to a global shared memory range, following a uniform distribution of participants, the following observations can be made. A remote atomic-based approach yields ‘T*N’ memory operations to the targeted address range and ‘T*N*S’ bytes transferred. This means that in the worst case, both traffic to the memory and congestion at the backing memories is in the order of the number of threads participating in the computation.

A cache coherence approach with default initial values yields ‘W*C*N’ memory operations and ‘W*C*N*S’ bytes transferred, where ‘W’ represents how many times a line may be written back (if for instance it was evicted prematurely). The thread count ‘T’ disappears from the formula since these operations are now kept local to their respective cache domains. In this case, both traffic to the memory and congestion at the memory are on the order of the number of cache coherence domain participating in the computation.

One important factor to differentiate performance is that the total thread count ‘T’ can be expected to be several orders of magnitude larger than the total number of coherence domains ‘C’, which means the traffic to and contention at backing memories is reduced by that factor.

### Indicating Reduce-On-Writeback Operations

Embodiments of the invention perform combination reduction operations in the cache coherency domains and using remote atomics near (or integral to) memory controllers. The cache coherency domains, memory controllers and corresponding interconnect fabrics are referred to generally as the “memory subsystem.” In these implementations, cached memory requests are marked to indicate that the corresponding data will be reduced once evicted or flushed from the cache (e.g., when performing writeback operations). For example, the cache controller may store an indication for each cacheline to indicate whether a remote atomic operations will be performed when the cacheline is written back to memory. In some embodiments, the cache controller tracks cachelines requiring remote atomic operations along with an indication of the reduction operation to be performed and generates the remote atomic packets issued upon cacheline evictions or flushes. In addition, the near-memory atomic units may be configured to process the instruction packets emitted from the cache (which have wider data fields compared with prior implementations). A remote atomic packet means any packet capable of indicating an operation to be performed by a remote atomic unit and data associated with the operation is sometimes referred to as an “command packet” or “reduction command packet.”

Embodiments of the invention expose this capability to the programmer. In one embodiment, this is accomplished with dynamic marking of “reduce-on-writeback” using hints supported by the ISA. For example, a reduce.cache.hint instruction may be scheduled to immediately precede a cached read or write. Details for one embodiment of a reduce.cache.hint instruction are shown in Table 7 below, including a field to indicate the reduction operation type (op_type) that will be tagged with the address as it is held in the cache and an input argument for setting the initial value for the reduction (r1). The initial value prevents the current value held in memory from being included multiple times in the reduction by different coherency islands that are participating in the reduction and may be zero or non-zero depending on the reduction operation type (op_type).

Note that this instruction is not required when a cached read or write does not use the reduce-on-writeback functionality. Also, any accesses to addresses that use reduce-on-writeback for a region of code will need this instruction to always precede them, given that the cache line at any point may be evicted without the programmer's knowledge.

TABLE 7

| Instruction | ASM form Arguments |
|---|---|
| reduce.cache.hint | r1, op_type |
| | r1 = initial reduction value that the allocated cachline |
| | block will be set to. op_type = Reduction operation |
| | that will occur near-memory on write-back. |
| | Operations include: add/sub, mul, min/max, bitop. |

One benefit of this implementation is that fewer architectural modifications are required. Specifically, relatively minor pipeline modifications are needed to support a single instruction and attach the corresponding hint to a follow-on cache access before sending the request to the cache. No additional storage or configuration registers within the pipeline itself are needed. Inserting a hint before only certain cache accesses will affect the software toolchain. Short of explicit invocations from the application programmer on every use, the compiler needs to provide attributes to mark variables subject to the reduction operation at variable declaration time. Similarly, the programming system may expose some form of annotation, for example pragmas in OpenMP. These mechanisms provide the necessary information for the compiler to automatically insert the hints before relevant instructions. These compiler implementations are tractable for relatively self-contained codes where the instructions accessing the cached addresses are readily analyzable (not calling into pre-compiled or dynamically loaded libraries) and the compiler can easily reason about addresses (no complex pointer manipulations resulting in obfuscation).

In some embodiments (which may be used alone or in combination with the above embodiments), software pre-configures address ranges for “reduce-on-writeback” operations. A memory-mapped table may be provided to configure memory addresses (or address ranges) which are marked as reduce-on-writeback when these address requests arrive at the cache. This implementation places the responsibility of configuring the table on the application programmer or the runtime system (rather than via toolchain modifications).

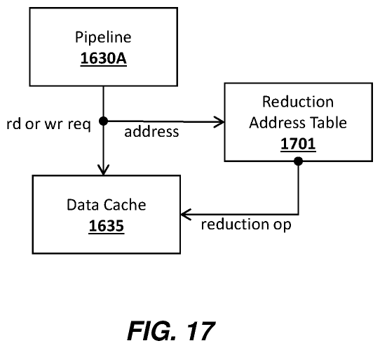

An example of the pre-configured address range implementation is illustrated in FIG. 17, which shows a reduction address table 1701 coupled to pipeline 1630A. In response to a read or write request generated from the pipeline 1630A, the corresponding address is used to perform a lookup in the reduction address table 1701 to determine if the address is within a specified “reduce-on-writeback” range. If so, an indication of a reduction operator is provided to the data cache 1635. In some embodiments, the read or write request is first received by the data cache 1635, which generates the address to perform the lookup in the reduction address table 1701.

In some embodiments, the reduction address table 1701 is a hardware structure that holds multiple entries and allows the programmer to write via targeted loads and stores to each slot's memory address. The data cache 1635 may refer to the table structure on every read or write and execute a lookup of the requested address to determine whether it falls within the configured ranges. If so, it marks the address as reduce-on-writeback and assigns the reduction operator stored in the lookup table to the address.

The contents of an entry of one embodiment of the reduction address table 1701 are shown in Table 8. The single entry will hold the high and low addresses of a range for address matching, as well as the reduction operation to be executed near-memory when the cache contents are evicted or flushed.

TABLE 8

| Field | Description |
|---|---|
| Address | 64-bit address setting the low-end of the |
| Range Low | configured range |
| Address | 64-bit address setting the high-end of the |
| Range High | configured range |
| Reduction | 3-bit field defining the operation type to be |
| Operator | executed near-memory. Operations include |
| | add/sub, mul, min/max, and bitop |
| Initial Value | 64-bit initial reduction value to which the |
| | allocated cacheline block is set |

While register structure that is local to the pipeline's cache may store the reduction address table 1701 (or portions thereof), the underlying principles of the invention are not so limited. Different implementations of the reduction address table 1701 may be used, depending on the processor architecture and the programmer requirements. While a local register set provides a low-latency access to the table 1701 for each request, the software cost for configuration may become expensive if all threads (on different pipelines) need their own local tables programmed with similar entries.

In one embodiment, the reduction address table 1701 is stored in memory and cached locally as needed. This embodiment reduces software costs associated with configuration and re-configuration. However, caching the entries of the reduction address table 1701 may add latency and energy consumption to all cache accesses.

In some embodiments, page table entries (PTEs) are configured to store the “reduce-on-writeback” information (e.g., via a reduce-on-writeback bit or bitfield). These embodiments eliminate the hardware overheads associated with register and cache storage. Additionally, there is little overhead associated with including this information in PTE's. However, the desired granularity for reduce-on-writeback addresses is smaller than typical page sizes, and therefore may not efficiently map to page-table specifications. In some embodiments, the reduce-on-writeback information may be specified at the granularity of pages or contiguous pages to overcome these limitations.

Embodiments of the invention may use any or all of the above techniques to indicate the reduce-on-writeback information. In one specific implementation, local registers with very few unique entries are used that are programmed by a local thread before executing the code segment utilizing the reduced address.

### Cache Modifications

The cache implementations for reduce-on-writeback operations are independent of the techniques for indicating reduce-on-writeback described above. In some embodiments, when a data element is marked as a cached reduction, an initial value may be provided to begin the reduction (e.g. as specified by a programmer), thereby preventing multiple caches in separate coherency islands from reading the same value from memory and having that value contribute to the reduction multiple times. Therefore, when receiving a read request for a cache reduction on a data block that misses in the cache, one embodiment of the cache fetches the full cacheline from memory and allocates that data block locally with the provided initial data value (and marks the block as dirty). When receiving a write request for a cache reduction on a data block that misses in the cache, the cache fetches the full cache line from memory and allocates the data block locally with the write data (ignoring the initial reduction value). Any cached reduction requests that hit in the cache execute normally and ignore the initial reduction value.

To maintain an indication that an address will be executing a near-memory reduction and the identity of the operation, the cache includes additional storage for each cache line currently held in the cache. The total size of each entry is dependent on the cache line granularity. In one embodiment, for a cache line width of 64-Bytes with a standard data size of 8-Bytes, the cache line will track eight reduction opcodes. Each opcode is 3-bits to support the selection of add, mul, min/max, and bitop. Therefore, this embodiment requires only 24 bits of additional storage per cacheline.

When a cache line is flushed or evicted, the cache controller checks this reduction opcode storage value. If any 8-Byte field in the cache line is marked with a reduction operator, the cache controller sends the full 64-Byte cacheline as a remote atomic operation, with the reduction operators for each 8-Byte data field sent along with the packet. The remote atomic unit then applies the reduction operations accordingly (as described below).

Note that only modified and marked sub-blocks within the cacheline will be executed with a reduction at the destination memory. If a block is not dirty, no change will happen at the memory. If a block is dirty but not marked with a reduction operator, it will only overwrite the currently held value in memory. If a block is dirty and marked with a reduction operator, it will be reduced (with the specified operation) with the value currently held in memory.

### Remote Atomic Unit Implementations

To support cacheline reductions, embodiments of the near-memory atomic unit receive requests for (aligned) 64-Bytes of data, requiring the atomic unit to lock a full 64-Byte cacheline, read the cacheline out of memory, execute the reduction operation, and write the full 64-Byte result back to memory.

Even though the full 64-Byte cacheline is read and updated atomically, the atomic unit can treat each 8-Byte sub-block within the 64-Byte cacheline separately, depending on the specified reduction operation received. This results in up to eight unique compute operations executed on the 64-Byte cacheline in parallel.

One embodiment of the atomic unit is configured to sustain the throughput of the local memory interface such that a high rate of remote atomics targeting the same physical memory locations will not create significant backpressure and reduce system performance. Past approaches focusing on 8-Byte (or less) operations implemented only a single pipelined execution path. However, to support parallel operations within the full 64-Byte cachelines, embodiments of the invention take a vector-like approach by implementing eight parallel execution units for each 8-Byte block within the cacheline.

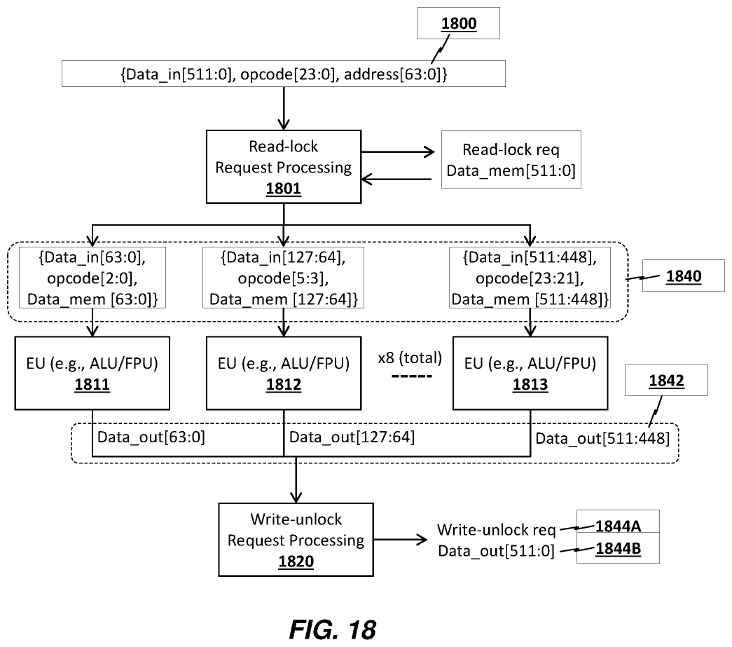

FIG. 18 illustrates one embodiment of the atomic unit which receives the full instruction packet 1800, including the target address of the 64-Byte cacheline, the 64-Byte source data, and a 24-bit field with the eight reduction opcodes for each block. Read-lock request processing logic 1801 (e.g., implemented by a handler) performs a read-lock request operation to read the data from the local memory. The data field is then subdivided among the eight parallel execution units 1811-1813 (only three of which are shown) which operate on a corresponding 8-Byte block (i.e., assuming a reduction op is requested by the instruction for that 8-Byte block). Once the operations have completed, write-unlock request processing logic constructs the 64-Byte cacheline 1844B from the 8-Byte results 1842 which it writes back with a write-unlock operation 1844A.

### Software Integration

One embodiment of a programming model is the OpenMP programming interface which defines parallel regions of code. In such a context, a programmer can provide the necessary information for a compiler to generate the necessary hardware ISA invocations in the prologue and epilogue of such regions of code. Namely, a set of addresses (e.g., pointers to an array stored in memory), a length in bytes (e.g., the size of the array stored in memory), and a reduction operator which can include, but is not limited to, addition, subtraction, multiplication, min, max, or bitwise manipulation. The data type is known at compile time by inspecting the pointer type.

In a parallel region prologue, the cache coherence domain is made aware of the address range, length, and reduction operator. Optionally, the cache may be instructed to not fetch the data from memory but initialize it locally to a default value. In the body of the parallel region, the cache coherence domain acts as a traditional cache system and its operation requires no coordination with other domains. On a write back operation, the cached data is sent to the backing memory along with metadata allowing for the reconciliation to take place there. The cached data is then invalidated. Similarly, in a parallel region's epilogue, the cache is instructed to perform a write back invalidate operation such that there's no data marked with reduction attributes left in the cache for that parallel region.

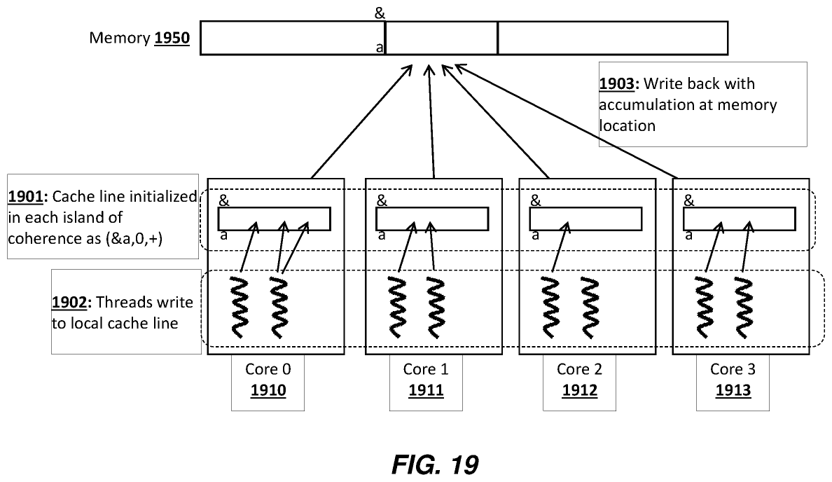

FIG. 19 illustrates one embodiment with a plurality of cores 1910-1913, where the cache of each core stores a cacheline at address “a” in a separate island of coherence. As indicated at 1901, each cache line is locally initialized to zero and the reduction operation used to reconcile the data is the “sum” operation. As indicated at 1902, the threads running on each core are free to write into the local cache line irrespective of the state of the other islands of coherence. When a core is evicting the cache line or software instructs to do so, the data from the cacheline is written back to memory 1950. As indicated at 1903, each core's contributions are accumulated at the memory 1950. Without this mechanism, all the threads would have to contend to atomically increment the memory location or organize some form of software-managed hierarchical reduction.

In the example code sequence below, a function is called by many threads collaborating to create a histogram by incrementing specific cells of an array (hist) whenever a given value is read from some source input array (input). The code shows how a compiler built-in can be used to instruct the cache system of the reduction requirements. The loop performing the work is left unchanged. Before exiting this parallel region, the cache content is written back to memory so that all threads can later synchronize and observe the updated content in the backing memory. Such builtins can also be generated by a higher-level form of compiler or programming paradigm such as OpenMP pragmas.

```
void hist(int start, int stop, int * input, int N, int * hist, int H) {
  // here, inject instruction to decorate the ‘hist’ array to have
  // local content initialized as zero and reduction operator to be sum
  _builtin_cache_reduction(hist, N*size(int), 0, OP_SUM);
  for (int i=start; i<stop; i++) {
    int value = input[i];
    atomic_incr(&hist[value], 1);
  }
  // force write back before all threads synchronize their view
  _builtin_cache_writeback(hist, N*size(int));
}
```

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

### Examples

The following are example implementations of different embodiments of the invention.

Example 1. A processor, comprising: a plurality of instruction processing pipelines, each instruction processing pipeline to process sequences of instructions; an interconnect coupled to the plurality of instruction processing pipelines; and a memory subsystem coupled to plurality of instruction processing pipelines over the interconnect, the memory subsystem comprising a plurality of atomic operation circuits corresponding to a plurality of memory interfaces to be coupled to a corresponding plurality of memories, each atomic operation circuit configured to perform a corresponding reduction operation with first data stored a memory of the plurality of memories and second data indicated in a command packet, the atomic operation circuit to generate result data based on the reduction operation which is to be stored in the memory.

Example 2. The processor of example 1 wherein the memory subsystem further comprises a plurality of caches to store cachelines, at least some of the cachelines associated with remote atomic operations.

Example 3. The processor of examples 1 Or 2 wherein a cache of the plurality of caches comprises a cache controller to identify the cachelines associated with remote atomic operations based on at least one of: an address range associated with remote atomic operations and a reduction operation hint instruction included in the sequences of instructions.

Example 4. The processor of any of examples 1-3 wherein each of the cachelines comprises or is associated with a field to indicate if a corresponding cacheline is associated with a remote atomic operation.

Example 5. The processor of any of examples 1-4 wherein the cache controller is to generate the command packet responsive to a writeback or a writethrough operation on a cacheline associated with a remote atomic operation.

Example 6. The processor of any of examples 1-5 wherein the remote atomic operation comprises a reduction operation, wherein the command packet is to indicate a particular reduction operation to be performed, the reduction operation comprising at least one of: a minimum or maximum operation, an addition or subtraction, an accumulation, a multiplication, and a bit manipulation operation.

Example 7. The processor of any of examples 1-6 wherein an atomic operation circuit comprises a plurality of execution units to perform a corresponding plurality of reduction operations, one of the corresponding plurality of reduction operations comprising the corresponding reduction operation with the first data and the second data to generate the result data.

Example 8. The processor of any of examples 1-7 wherein the command packet is to indicate a separate reduction operation for each execution unit of the plurality of execution units.

Example 9. The processor of any of examples 1-8 wherein the command packet comprises a first command packet, wherein the atomic operation unit is to receive a second command packet and responsively execute one or more additional reduction operations.

Example 10. The processor of any of examples 1-9 wherein the cache controller is to identify the cachelines associated with remote atomic operations by accessing a reduction address table, the reduction address table to store a plurality of entries, each entry including a plurality of fields to indicate an address range and a reduction operation to be performed when a cacheline associated with the address range is evicted or flushed.

Example 11. A method, comprising: processing sequences of instructions by a plurality of instruction processing pipelines; tracking modifications of cachelines in a cache within a memory subsystem; transmitting a command packet indicating a corresponding reduction operation to an atomic operation circuit associated with a memory interface coupled to a memory; and performing, by the atomic operation circuit, a corresponding reduction operation with first data stored in a memory of the plurality of memories and second data associated with the modifications of the cachelines, the second data indicated in the command packet, wherein the atomic operation circuit is to generate result data based on the corresponding reduction operation, the result data to be stored in the memory.

Example 12. The method of example 11 wherein the cache comprises a first cache, the memory subsystem comprising a plurality of caches including the first cache, wherein the modifications of the cacheline are performed on cachelines associated with remote atomic operations.

Example 13. The method of examples 11 or 12 wherein the first cache comprises a cache controller to identify the cachelines associated with remote atomic operations based on at least one of: an address range associated with remote atomic operations and a reduction operation hint instruction included in the sequences of instructions.

Example 14. The method of any of examples 11-13 wherein the cachelines of the first cache each include a field or are associated with a field to indicate if a corresponding cacheline is associated with a remote atomic operation.

Example 15. The method of any of examples 11-13 wherein the cache controller is to generate the command packet responsive to a writeback or a writethrough operation on a cacheline associated with a remote atomic operation.

Example 16. The method of any of examples 11-14 wherein the remote atomic operation comprises a reduction operation, wherein the command packet is to indicate a particular reduction operation to be performed, the reduction operation comprising at least one of: a minimum or maximum operation, an addition or subtraction, an accumulation, a multiplication, and a bit manipulation operation.

Example 17. The method of any of examples 11-16 wherein an atomic operation circuit comprises a plurality of execution units to perform a corresponding plurality of reduction operations, one of the corresponding plurality of reduction operations comprising the corresponding reduction operation with the first data and the second data to generate the result data.

Example 18. The method of any of examples 11-17 wherein the command packet is to indicate a separate reduction operation for each execution unit of the plurality of execution units.

Example 19. The method of any of examples 11-18 wherein the command packet comprises a first command packet, the method further comprising: receiving, by an atomic operation unit, a second command packet; responsively executing, by the atomic operation unit, one or more additional reduction operations.

Example 20. The method of any of examples 11-19 wherein the cache controller is to identify the cachelines associated with remote atomic operations by accessing a reduction address table, the reduction address table to store a plurality of entries, each entry including a plurality of fields to indicate an address range and a reduction operation to be performed when a cacheline associated with the address range is evicted or flushed.

Example 21. A machine-readable medium having program code stored thereon which, when executed by a machine, causes the machine to perform operations, comprising: processing sequences of instructions by a plurality of instruction processing pipelines; tracking modifications of cachelines in a cache within a memory subsystem; transmitting a command packet indicating a corresponding reduction operation to an atomic operation circuit associated with a memory interface coupled to a memory; and performing, by the atomic operation circuit, a corresponding reduction operation with first data stored in a memory of the plurality of memories and second data associated with the modifications of the cachelines, the second data indicated in the command packet, wherein the atomic operation circuit is to generate result data based on the corresponding reduction operation, the result data to be stored in the memory.

Example 22. The machine-readable medium of example 21 wherein the cache comprises a first cache, the memory subsystem comprising a plurality of caches including the first cache, wherein the cacheline modifications are performed on cachelines associated with remote atomic operations.

Example 23. The machine-readable medium of examples 21 or 22 wherein the first cache comprises a cache controller to identify the cachelines associated with remote atomic operations based on at least one of: an address range associated with remote atomic operations and a reduction operation hint instruction included in the sequences of instructions.

Example 24. The machine-readable medium of any of examples 21-23 wherein the cachelines of the first cache each include a field or are associated with a field to indicate if the corresponding cacheline is associated with a remote atomic operation.

Example 25. The machine-readable medium of any of examples 21-24 wherein the cache controller is to generate the command packet responsive to a writeback or a writethrough operation on a cacheline associated with a remote atomic operation.

Example 26. The machine-readable medium of any of examples 21-25 wherein the remote atomic operation comprises a reduction operation, wherein the command packet is to indicate a particular reduction operation to be performed, the reduction operation comprising at least one of: a minimum or maximum operation, an addition or subtraction, an accumulation, a multiplication, and a bit manipulation operation.

Example 27. The machine-readable medium of any of examples 21-26 wherein an atomic operation circuit comprises a plurality of execution units to perform a corresponding plurality of reduction operations, one of the corresponding plurality of reduction operations comprising the corresponding reduction operation with the first data and the second data to generate the result data.

Example 28. The machine-readable medium of any of examples 21-27 wherein the command packet is to indicate a separate reduction operation for each execution unit of the plurality of execution units.

Example 29. The machine-readable medium of any of examples 21-28 wherein the command packet comprises a first command packet, the machine-readable medium further comprising program code to cause the operations of: receiving, by an atomic operation unit, a second command packet; responsively executing, by the atomic operation unit, one or more additional reduction operations.

Example 30. The machine-readable medium of any of examples 21-29 wherein the cache controller is to identify the cachelines associated with remote atomic operations by accessing a reduction address table, the reduction address table to store a plurality of entries, each entry including a plurality of fields to indicate an address range and a reduction operation to be performed when a cacheline associated with the address range is evicted or flushed.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals-such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. A processor, comprising:
a plurality of instruction processing pipelines, each instruction processing pipeline to process sequences of instructions;
an interconnect coupled to the plurality of instruction processing pipelines; and
a memory subsystem coupled to plurality of instruction processing pipelines over the interconnect, the memory subsystem comprising a plurality of atomic operation circuits corresponding to a plurality of memory interfaces to be coupled to a corresponding plurality of memories, each atomic operation circuit configured to perform a corresponding reduction operation with first data stored a memory of the plurality of memories and second data indicated in a command packet, the atomic operation circuit to generate result data based on the reduction operation which is to be stored in the memory.

2. The processor of claim 1 wherein the memory subsystem further comprises a plurality of caches to store cachelines, at least some of the cachelines associated with remote atomic operations.

3. The processor of claim 2 wherein a cache of the plurality of caches comprises a cache controller to identify the cachelines associated with remote atomic operations based on at least one of: an address range associated with remote atomic operations and a reduction operation hint instruction included in the sequences of instructions.

4. The processor of claim 3 wherein each of the cachelines comprises or is associated with a field to indicate if a corresponding cacheline is associated with a remote atomic operation.

5. The processor of claim 3 wherein the cache controller is to generate the command packet responsive to a writeback or a writethrough operation on a cacheline associated with a remote atomic operation.

6. The processor of claim 4 wherein the remote atomic operation comprises a reduction operation, wherein the command packet is to indicate a particular reduction operation to be performed, the reduction operation comprising at least one of: a minimum or maximum operation, an addition or subtraction, an accumulation, a multiplication, and a bit manipulation operation.

7. The processor of claim 6 wherein an atomic operation circuit comprises a plurality of execution units to perform a corresponding plurality of reduction operations, one of the corresponding plurality of reduction operations comprising the corresponding reduction operation with the first data and the second data to generate the result data.

8. The processor of claim 7 wherein the command packet is to indicate a separate reduction operation for each execution unit of the plurality of execution units.

9. The processor of claim 8 wherein the command packet comprises a first command packet, wherein the atomic operation unit is to receive a second command packet and responsively execute one or more additional reduction operations.

10. The processor of claim 3 wherein the cache controller is to identify the cachelines associated with remote atomic operations by accessing a reduction address table, the reduction address table to store a plurality of entries, each entry including a plurality of fields to indicate an address range and a reduction operation to be performed when a cacheline associated with the address range is evicted or flushed.

11. A method, comprising:
processing sequences of instructions by a plurality of instruction processing pipelines;
tracking modifications of cachelines in a cache within a memory subsystem;
transmitting a command packet indicating a corresponding reduction operation to an atomic operation circuit associated with a memory interface coupled to a memory; and
performing, by the atomic operation circuit, a corresponding reduction operation with first data stored in a memory of the plurality of memories and second data associated with the modifications of the cachelines, the second data indicated in the command packet, wherein the atomic operation circuit is to generate result data based on the corresponding reduction operation, the result data to be stored in the memory.

12. The method of claim 11 wherein the cache comprises a first cache, the memory subsystem comprising a plurality of caches including the first cache, wherein the modifications of the cacheline are performed on cachelines associated with remote atomic operations.

13. The method of claim 12 wherein the first cache comprises a cache controller to identify the cachelines associated with remote atomic operations based on at least one of: an address range associated with remote atomic operations and a reduction operation hint instruction included in the sequences of instructions.

14. The method of claim 13 wherein the cachelines of the first cache each include a field or are associated with a field to indicate if a corresponding cacheline is associated with a remote atomic operation.

15. The method of claim 13 wherein the cache controller is to generate the command packet responsive to a writeback or a writethrough operation on a cacheline associated with a remote atomic operation.

16. The method of claim 14 wherein the remote atomic operation comprises a reduction operation, wherein the command packet is to indicate a particular reduction operation to be performed, the reduction operation comprising at least one of: a minimum or maximum operation, an addition or subtraction, an accumulation, a multiplication, and a bit manipulation operation.

17. The method of claim 16 wherein an atomic operation circuit comprises a plurality of execution units to perform a corresponding plurality of reduction operations, one of the corresponding plurality of reduction operations comprising the corresponding reduction operation with the first data and the second data to generate the result data.

18. A machine-readable medium having program code stored thereon which, when executed by a machine, causes the machine to perform operations, comprising:
processing sequences of instructions by a plurality of instruction processing pipelines;
tracking modifications of cachelines in a cache within a memory subsystem;
transmitting a command packet indicating a corresponding reduction operation to an atomic operation circuit associated with a memory interface coupled to a memory; and
performing, by the atomic operation circuit, a corresponding reduction operation with first data stored in a memory of the plurality of memories and second data associated with the modifications of the cachelines, the second data indicated in the command packet, wherein the atomic operation circuit is to generate result data based on the corresponding reduction operation, the result data to be stored in the memory.

19. The machine-readable medium of claim 18 wherein the cache comprises a first cache, the memory subsystem comprising a plurality of caches including the first cache, wherein the cacheline modifications are performed on cachelines associated with remote atomic operations.

20. The machine-readable medium of claim 19 wherein the first cache comprises a cache controller to identify the cachelines associated with remote atomic operations based on at least one of: an address range associated with remote atomic operations and a reduction operation hint instruction included in the sequences of instructions.
